(19) United States
(12) Patent Application Publication
(10) Pub. No.: US 2025/0251636 A1
(43) Pub. Date: Aug. 7, 2025

(54) DISPLAY SUBSTRATE AND DISPLAY DEVICE

(71) Applicant: Sharp Display Technology Corporation, Kameyama City (JP)

(72) Inventor: Noriyuki OHASHI, Kameyama City (JP)

(21) Appl. No.: 19/020,123

(22) Filed: Jan. 14, 2025

(30) Foreign Application Priority Data
Feb. 5, 2024 (JP) 2024-015665

(51) Int. Cl. G02F 1/1362

(52) U.S. Cl. CPC G02F 1/136286

(57) ABSTRACT

A first wiring and a second wiring both intersect with a first inclined side portion, a third wiring has a first wiring unit made of a part of a first conductive film and a second wiring unit made of a part of a first metal film or a second conductive film, the second wiring unit is connected to the first wiring unit and the first wiring, a fourth wiring has a third wiring unit made of a part of the second metal film and a fourth wiring unit made of a part of the first metal film or the second metal film, the third wiring unit is arranged to overlap the first wiring unit, and the fourth wiring unit is arranged not to overlap the second wiring unit and is connected to the third wiring unit and the second wiring.

### CROSS-REFERENCE TO RELATED APPLICATIONS

This application claims the benefit of priority to Japanese Patent Application Number 2024-015665 filed on Feb. 5, 2024. The entire contents of the above-identified application are hereby incorporated by reference.

### BACKGROUND

### Technical Field

The technology disclosed in this specification relates to a display substrate and a display device.

In the related art, an example of a liquid crystal display device is known as disclosed in JP 6065125 B. The liquid crystal display device disclosed in JP 6065125 B includes a display device substrate including a first touch sensing wiring line, an array substrate including a second touch sensing wiring line orthogonal to the first touch sensing wiring line, a liquid crystal layer interposed between the display device substrate and the array substrate, and a control unit that supplies a positive first image signal to a first source wiring line, supplies a negative second image signal to a second source wiring line, and drives the liquid crystal layer by applying a liquid crystal drive voltage between a pixel electrode and a common electrode in synchronization with the supply of the first image signal and the second image signal to display an image, and that applies a voltage to the second touch sensing wiring line after the image is displayed.

### SUMMARY

In a liquid crystal display device disclosed in JP 6065125 B described above, a predetermined image signal is supplied from an image signal timing control unit to each of a first source wiring line and a second source wiring line. Thus, an array substrate is provided with a lead-out wiring line for connecting the first source wiring line to the image signal timing control unit and a lead-out wiring line for connecting the second source wiring line to the image signal timing control unit. These lead-out wiring lines are disposed in a non-display region of the array substrate where images are not displayed. As the number of source wiring lines increases with higher definition, the number of lead-out wiring lines also increases, resulting in a problem that the width of the non-display region, that is, a frame width, becomes wider. In particular, when the liquid crystal display device has a non-rectangular shape and the outer peripheral side portion of a display region where images are displayed includes an inclined side portion inclined relative to the source wiring line, there is a problem that a frame width near the inclined side portion is likely to become wider due to the lead-out wiring lines.

The technique described herein has been made based on the circumstances described above, and is directed to making the frame smaller.

(1) A display substrate according to the technology described in this specification includes a display region in which an image is displayed, a non-display region in which an image is not displayed, a first signal supply unit that is disposed in the non-display region at a position spaced apart from the display region in a first direction, a first wiring line that is disposed in the display region and extends in the first direction, a second wiring line that is disposed in the display region and extends in the first direction, a third wiring line that is disposed in the non-display region and is connected to the first signal supply unit and the first wiring line, and a fourth wiring line that is disposed in the non-display region and is connected to the first signal supply unit and the second wiring line, in which an outer peripheral side portion in the display region includes a first inclined side portion that is inclined in the first direction such that a distance from the first signal supply unit increases toward an end in a second direction orthogonal to the first direction, the first wiring line and the second wiring line are both disposed intersecting the first inclined side portion, the third wiring line includes a first wiring line portion constituted by a part of a first conductive film and a second wiring line portion constituted by a part of the first conductive film or a second conductive film with a first insulating film interposed between the first conductive film and the second conductive film, the second wiring line portion is connected to the first wiring line portion and the first wiring line, the fourth wiring line includes a third wiring line portion constituted by a part of the second conductive film and a fourth wiring line portion constituted by a part of the first conductive film or the second conductive film, the third wiring line portion is disposed overlapping the first wiring line portion, and the fourth wiring line portion is disposed not to overlap the second wiring line portion and is connected to the third wiring line portion and the second wiring line.

(2) In addition to (1) described above, the display substrate may further include a fifth wiring line that is disposed in the display region and extends in the second direction; and
a second signal supply unit that is disposed in the non-display region and is connected to the fifth wiring line to supply a signal to the fifth wiring line, in which the second signal supply unit extends along the first inclined side portion and is disposed at a position spaced apart from the first inclined side portion, and the third wiring line and the fourth wiring line are disposed being interposed between the first inclined side portion and the second signal supply unit.

(3) In addition to (1) described above, the display substrate may further include a fifth wiring line that is disposed in the display region and extends in the second direction, and a second signal supply unit that is disposed in the non-display region and is configured to supply a signal to the fifth wiring line, in which the second signal supply unit extends along the first inclined side portion and is disposed at a position adjacent to the first inclined side portion, and the third wiring line and the fourth wiring line are disposed sandwiching the second signal supply unit between them and the first inclined side portion.

(4) In addition to the above (3), the display substrate may further include a sixth wiring line that is disposed in the display region and extends in the second direction, a seventh wiring line that is disposed in the non-display region and is connected to the fifth wiring line and the second signal supply unit, and an eighth wiring line that is disposed in the non-display region and is connected to the sixth wiring line and the second signal supply unit, in which the fifth wiring line, the sixth wiring line, the seventh wiring line, the eighth wiring line, and the first wiring line portion are each constituted by a part of the first conductive film, the first wiring line, the second wiring line, the third wiring line portion, and the fourth wiring line portion are each constituted by a part of the second conductive film, the fourth wiring line portion intersects the eighth wiring line via the first insulating film, the second wiring line portion connects a first conductive film portion constituted by a part of the first conductive film and a second conductive film portion constituted by a part of the second conductive film through a first contact hole formed in the first insulating film, and the second conductive film portion intersects the seventh wiring line via the first insulating film.

(5) In addition to (3) or (4) described above, the display substrate may further include a ninth wiring line that is disposed in the non-display region and is connected to the second signal supply unit, in which the ninth wiring line extends along the first inclined side portion and is disposed sandwiching the third wiring line and the fourth wiring line between the ninth wiring line and the second signal supply unit.

(6) In addition to (1) described above, the display substrate may further include a tenth wiring line and an eleventh wiring line that are disposed in the display region and both extend in the first direction, and a switch circuit that is disposed in the non-display region and is connected to the first wiring line, the second wiring line, the third wiring line, the fourth wiring line, the tenth wiring line, and the eleventh wiring line, in which the switch circuit distributes signals transmitted by the third wiring line to the first wiring line and the tenth wiring line and distributes signals transmitted by the fourth wiring line to the second wiring line and the eleventh wiring line, the switch circuit extending along the first inclined side portion and being disposed at a position adjacent to the first inclined side portion, and the third wiring line and the fourth wiring line are disposed sandwiching the switch circuit between them and the first inclined side portion.

(7) In addition to (6) described above, the display substrate may further include a fifth wiring line that is disposed in the display region and extends in the second direction, and a second signal supply unit that is disposed in the non-display region and is connected to the fifth wiring line to supply a signal to the fifth wiring line, in which the second signal supply unit extends along the first inclined side portion and is disposed at a position spaced apart from the switch circuit, and the third wiring line and the fourth wiring line are disposed being interposed between the switch circuit and the second signal supply unit.

(8) In addition to (6) described above, the display substrate may further include a fifth wiring line that is disposed in the display region and extends in the second direction, and a second signal supply unit that is disposed in the non-display region and is connected to the fifth wiring line to supply a signal to the fifth wiring line, in which the second signal supply unit extends along the first inclined side portion and is disposed at a position adjacent to the switch circuit, and the third wiring line and the fourth wiring line are disposed sandwiching the second signal supply unit between them and the switch circuit.

(9) In addition to any one of (1) to (8) described above, the display substrate may further include a twelfth wiring line that is disposed in the display region and extends in the first direction, and a thirteenth wiring line that is disposed in the non-display region and is connected to the first signal supply unit and the twelfth wiring line, in which the twelfth wiring line is disposed intersecting the first inclined side portion, the thirteenth wiring line includes a fifth wiring line portion constituted by a part of a third conductive film including a second insulating film, which is interposed between the third conductive film and the second conductive film, and a sixth wiring line portion constituted by a part of the first conductive film, the second conductive film, or the third conductive film, the fifth wiring line portion is disposed overlapping the first wiring line portion and the third wiring line portion, and the sixth wiring line portion is disposed not to overlap the second wiring line portion and the fourth wiring line portion, and is connected to the fifth wiring line portion and the twelfth wiring line.

(10) In addition to any one of (1) to (9) described above, in the display substrate, the second wiring line portion may be constituted by a part of the first conductive film, and the fourth wiring line portion may be constituted by a part of the second conductive film.

(11) In addition to any one of (1) to (9), in the display substrate, the fourth wiring line portion may be constituted by a part of the second conductive film, the second wiring line portion may connect a first conductive film portion, which is constituted by a part of the first conductive film, and a second conductive film portion, which is constituted by a part of the second conductive film, through a first contact hole formed in the first insulating film, and the second conductive film portion may be connected to the first wiring line.

(12) In addition to (11) described above, in the display substrate, the second conductive film portion and the fourth wiring line portion may be each constituted by a part of the second conductive film having a sheet resistance lower than a sheet resistance of the first conductive film.

(13) In addition to any one of (1) to (12) described above, in the display substrate, the outer peripheral side portion in the display region may include a first parallel side portion that is continuous with an end of the first inclined side portion on a first signal supply unit side and is parallel to the second direction, and the first wiring line portion and the third wiring line portion may extend to a side opposite to the first signal supply unit side from the first parallel side portion in the first direction.

(14) A display device according to the technology described in this specification includes the display substrate according to any one of (1) to (13) described above, and a counter substrate that is disposed facing the display substrate.

According to the technique described herein, it is possible to achieve a narrow frame.

### BRIEF DESCRIPTION OF DRAWINGS

The disclosure will be described with reference to the accompanying drawings, wherein like numbers reference like elements.

FIG. 1 is a plan view of a liquid crystal panel, a driver, a flexible substrate, and the like that constitute a liquid crystal display device according to a first embodiment.

FIG. 2 is a cross-sectional view of the liquid crystal panel, the driver, the flexible substrate, and the like according to the first embodiment.

FIG. 3 is a circuit diagram illustrating an electrical configuration of an array substrate that constitutes the liquid crystal panel according to the first embodiment.

FIG. 4 is a cross-sectional view illustrating a cross-sectional configuration near a TFT of the array substrate according to the first embodiment.

FIG. 5 is an enlarged plan view of the vicinity of a first inclined side portion of a display region of the array substrate according to the first embodiment.

FIG. 6 is a cross-sectional view of the array substrate according to the first embodiment which is taken along line vi-vi in FIG. 5.

FIG. 7 is a cross-sectional view of the array substrate according to the first embodiment which is taken along line vii-vii in FIG. 5.

FIG. 8 is a cross-sectional view of the array substrate according to the first embodiment which is taken along line viii-viii in FIG. 5.

FIG. 9 is an enlarged plan view of the vicinity of a first inclined side portion of a display region of an array substrate according to a second embodiment.

FIG. 10 is a cross-sectional view of the array substrate according to the second embodiment which is taken along line x-x in FIG. 9.

FIG. 11 is a cross-sectional view of the array substrate according to the second embodiment which is taken along line xi-xi in FIG. 9.

FIG. 12 is a plan view of a liquid crystal panel, a driver, a flexible substrate, and the like according to a third embodiment.

FIG. 13 is an enlarged plan view of the vicinity of a first inclined side portion of a display region of an array substrate according to the third embodiment.

FIG. 14 is a circuit diagram illustrating a circuit configuration of a switch circuit according to the third embodiment.

FIG. 15 is an enlarged plan view of the vicinity of a first inclined side portion of a display region of an array substrate according to a fourth embodiment.

FIG. 16 is an enlarged plan view of the vicinity of a first inclined side portion of a display region of an array substrate according to a fifth embodiment.

FIG. 17 is a cross-sectional view of the array substrate according to the fifth embodiment which is taken along line xvii-xvii in FIG. 16.

FIG. 18 is a cross-sectional view of the array substrate according to the fifth embodiment which is taken along line xviii-xviii in FIG. 16.

FIG. 19 is a cross-sectional view of the array substrate according to the fifth embodiment which is taken along line xix-xix in FIG. 16.

FIG. 20 is an enlarged plan view of the vicinity of a first inclined side portion of a display region of an array substrate according to a sixth embodiment.

FIG. 21 is an enlarged plan view of the vicinity of a first inclined side portion of a display region of an array substrate according to a seventh embodiment.

FIG. 22 is an enlarged plan view of the vicinity of a first inclined side portion of a display region of an array substrate according to an eighth embodiment.

### DESCRIPTION OF EMBODIMENTS

### First Embodiment

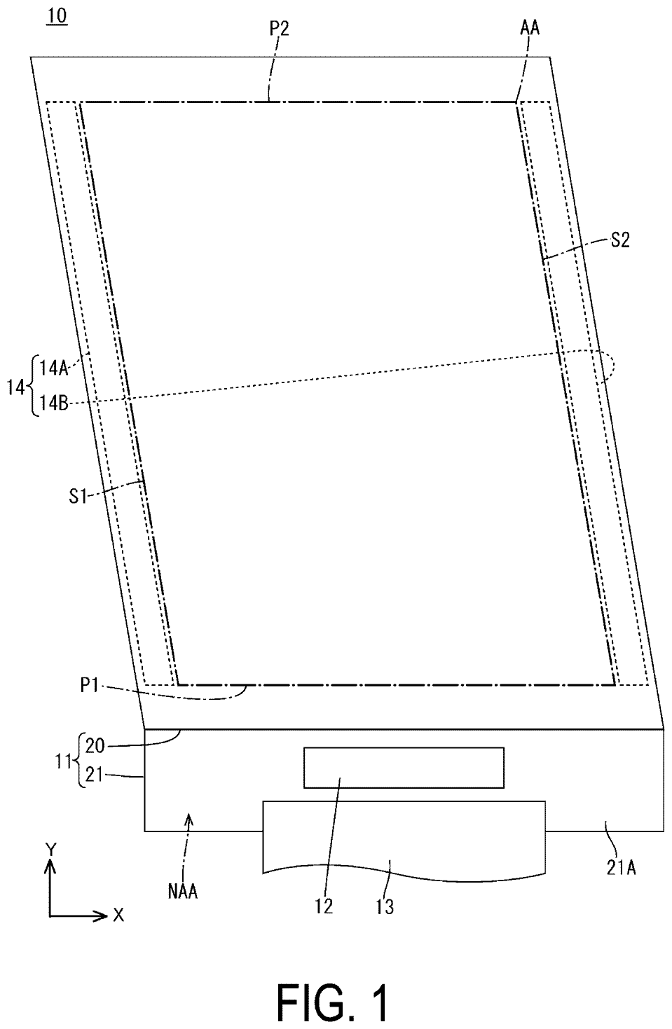

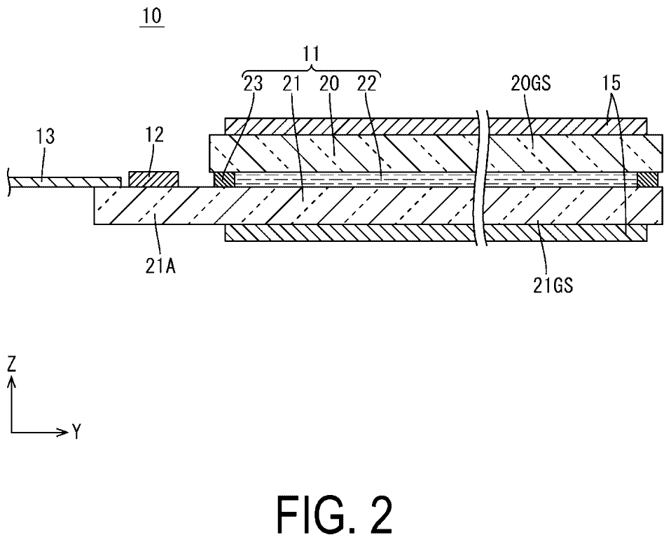

A first embodiment will be described with reference to FIGS. 1 to 8. In present embodiment, a liquid crystal display device 10 is exemplified. Some drawings illustrate an X-axis, a Y-axis, and a Z-axis, and directions of these axes are drawn to be common to all of the drawings. In addition, an upper side of each of FIGS. 2, 4, 6, 7 and 8 is a front side, and a lower side of each of the drawings is a back side.

As illustrated in FIG. 1, the liquid crystal display device 10 includes at least a liquid crystal panel (display device, display panel) 11 capable of displaying images, and a backlight device (illumination device) which is an external light source that irradiates the liquid crystal panel 11 with light to be used for display. The backlight device includes a light source (for example, an LED or the like) disposed on the back side (back face side) of the liquid crystal panel 11 and configured to emit light of a white color (white light), an optical member configured to impart an optical effect on the light from the light source to convert the light into planar light, and the like.

As illustrated in FIG. 1, in the liquid crystal panel 11, a central portion of a screen is a display region AA where an image is displayed, while a frame-shaped outer peripheral side portion of the screen which surrounds the display region AA is a non-display region NAA where no image is displayed. In the liquid crystal panel 11, the planar shape of a portion having the display region AA is a substantially parallelogram shape. Accordingly, the planar shape of the display region AA is also a substantially parallelogram shape. The outer peripheral side portion of the display region AA includes a pair of parallel side portions P1 and P2 parallel to each other in the X-axis direction (second direction) and a pair of inclined side portions S1 and S2 inclined with respect to the X-axis direction and the Y-axis direction (first direction). Out of the pair of parallel side portions P1 and P2, the first parallel side portion P1 is located on the lower side of FIG. 1 (the side of the driver 12 to be described later), and the second parallel side portion P2 is located on the upper side of FIG. 1. Out of the pair of inclined side portions S1 and S2, the first inclined side portion S1 is located on the left side of FIG. 1, and the second inclined side portion S2 is located on the right side of FIG. 1. Among these, the first inclined side portion S1 is inclined with respect to the Y-axis direction such that a distance from the driver 12 to be described later increases toward the end side in the X-axis direction (the left end side in FIG. 1). On the other hand, in the non-display region NAA, a planar shape on the inner peripheral side is a shape conforming to the planar shape of the display region AA, and a planar shape on the outer peripheral side is a shape conforming to the external form of the liquid crystal panel 11 when viewed in a plane. The range surrounded by the alternating dotted-dashed line in FIG. 1 is the display region AA.

As illustrated in FIG. 1, a gate drive circuit (second signal supply unit, gate circuit portion) 14 is provided in the non-display region NAA of the liquid crystal panel 11. A pair of gate drive circuits 14 are disposed sandwiching the display region AA from both sides in the X-axis direction. The pair of gate drive circuits 14 include a first gate drive circuit 14A disposed adjacent to the first inclined side portion S1 in the display region AA, and a second gate drive circuit 14B disposed adjacent to the second inclined side portion S2 in the display region AA. The gate drive circuits 14 are provided in a strip-shaped range extending along the adjacent inclined side portions S1 and S2. The gate drive circuit 14 is a unit for supplying a scanning signal to a gate wiring line 26 to be described later, and is provided monolithically on an array substrate 21 to be described later. The gate drive circuit 14 is a so-called gate driver monolithic (GDM) circuit. The gate drive circuit 14 includes a shift register circuit that outputs a scanning signal at a predetermined timing, a buffer circuit for amplifying the scanning signal, and the like.

The liquid crystal panel 11 will be described in detail with reference to FIG. 2 in addition to FIG. 1. As illustrated in FIGS. 1 and 2, the liquid crystal panel 11 is formed by bonding a pair of substrates 20 and 21 together. Out of the pair of substrates 20 and 21, the front side (front face side) is the counter substrate (CF substrate) 20, and the back side (back face side) is the array substrate (wiring line substrate) 21. Both the counter substrate 20 and the array substrate 21 are formed by layering various films on inner face sides of glass substrates (substrates) 20GS and 21GS. A liquid crystal layer (medium layer) 22 containing liquid crystal molecules, which are substances having optical characteristics that change in accordance with application of an electrical field, is interposed between the pair of substrates 20 and 21. A sealing portion 23 that seals the liquid crystal layer 22 is provided to be interposed between outer peripheral ends of the pair of substrates 20 and 21. The sealing portion 23 is formed in a rectangular frame-like shape (endless ring shape) to surround the liquid crystal layer 22. Polarizers 15 are bonded to the outer face sides of both the substrates 20 and 21, respectively.

As illustrated in FIGS. 1 and 2, the dimension of the counter substrate 20 in the Y-axis direction is shorter than the dimension of the array substrate 21 in the Y-axis direction. The counter substrate 20 is attached to the array substrate 21 so that one end in the Y-axis direction is aligned. Thus, the other end of the array substrate 21 in the Y-axis direction is exposed as an exposed portion 21A that protrudes laterally from the counter substrate 20. The entire exposed portion 21A is a non-display region NAA, and is equipped with a driver (first signal supply unit) 12 and a flexible substrate 13 for supplying various signals.

As illustrated in FIGS. 1 and 2, the driver 12 is mounted on the exposed portion 21A of the array substrate 21 by chip on glass (COG). The driver 12 is disposed in the exposed portion 21A at a position spaced apart from the display region AA in the Y-axis direction (first direction). The driver 12 includes an LSI chip having a drive circuit therein. The driver 12 processes various signals transmitted by the flexible substrate 13. The driver 12 supplies various signals (for example, image signals, and the like) to a circuit (for example, the gate drive circuit 14) and a wiring line (for example, a source wiring line 27 to be described below) provided on the array substrate 21. In the region of the array substrate 21 where the driver 12 is mounted, a terminal portion that is connected to a terminal (bump) on the driver 12 side is provided. The flexible substrate 13 is connected to the end of the exposed portion 21A on a side opposite to the display region AA in the Y-axis direction with respect to the driver 12, and is disposed sandwiching the driver 12 between it and the display region AA in the Y-axis direction. The flexible substrate 13 has a configuration in which a large number of wiring line patterns are formed on a base material made of a synthetic resin material (for example, a polyimide resin or the like) having insulating properties and flexibility. One end of the flexible substrate 13 is connected to the exposed portion 21A of the array substrate 21, and the other end is connected to an external circuit substrate (a control substrate or the like). In the region of the array substrate 21 to which the flexible substrate 13 is connected, a terminal portion that is connected to a terminal on the flexible substrate 13 side is provided.

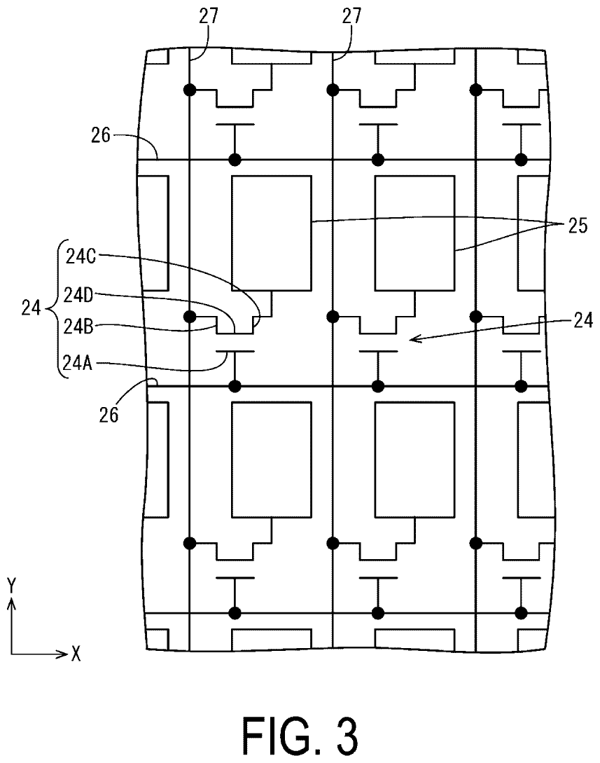

As illustrated in FIG. 3, at least TFTs (switching elements, transistors) 24 and pixel electrodes 25 are provided on the inner face side of the array substrate 21 in the display region AA. The plurality of TFTs 24 and the plurality of pixel electrodes 25 are provided in a matrix at intervals therebetween in the X-axis direction and the Y-axis direction. Gate wiring lines (scanning wiring lines) 26 and source wiring lines (image wiring lines, signal wiring lines) 27 orthogonal to (intersecting) each other are disposed around the TFTs 24 and the pixel electrodes 25. The gate wiring lines 26 extend in the X-axis direction, and a plurality of gate wiring lines are disposed side by side at intervals in the Y-axis direction. The source wiring lines 27 extend in the Y-axis direction (first direction), and a plurality of source wiring lines are disposed side by side at intervals in the X-axis direction. The TFT 24 includes a gate electrode 24A connected to the gate wiring line 26, a source electrode 24B connected to the source wiring line 27, a drain electrode 24C connected to the pixel electrode 25, and a semiconductor portion 24D connected to the source electrode 24B and the drain electrode 24C. The TFT 24 is driven on the basis of a scanning signal supplied to the gate electrode 24A by the gate wiring line 26. Then, a potential of an image signal (data signal) supplied from the driver 12 to the source electrode 24B through the source wiring line 27 is supplied to the drain electrode 24C through the semiconductor portion 24D. As a result, the pixel electrode 25 is charged to the potential related to the image signal. The pixel electrode 25 is disposed in a region surrounded by the gate wiring line 26 and the source wiring line 27, and has a planar shape which is, for example, a substantially rectangular shape that is vertically elongated.

On the other hand, on the inner face side of the counter substrate 20 in the display region AA, there are provided three color filters of red (R), green (G), and blue (B) disposed to overlap the pixel electrodes 25, and a light blocking portion (black matrix) that separates adjacent color filters. In the liquid crystal panel 11, the R, G, and B color filters arranged in the X-axis direction and the three pixel electrodes 25 facing the color filters constitute three color pixels (red pixels, green pixels, and blue pixels). The pixels are units of display in the display region AA, and are arranged in groups of a plurality of pixels at predetermined arrangement pitches in the X-axis direction and the Y-axis direction. In addition, as illustrated in FIG. 3, either the counter substrate 20 or the array substrate 21 is provided with a common electrode made of the same transparent electrode material as that of the pixel electrode 25 and disposed overlapping the pixel electrode 25 with a gap therebetween. In the liquid crystal panel 11, a predetermined electrical field is applied to the liquid crystal layer 22 on the basis of a potential difference generated between the common electrode and each pixel electrode 25, thereby enabling each pixel to display a predetermined gradation.

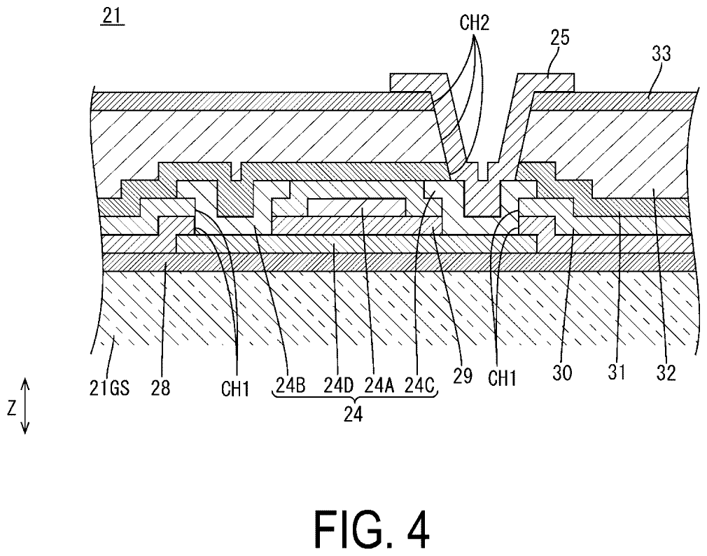

Here, various films formed layered on the inner face side of the array substrate 21 will be described with reference to FIG. 4. FIG. 4 illustrates a cross-sectional configuration of the array substrate 21 near the TFT 24. As illustrated in FIG. 4, on a glass substrate (substrate) 21GS of the array substrate 21, at least a base coat film 28, a semiconductor film, a gate insulating film 29, a first metal film (first conductive film), a first interlayer insulating film (first insulating film) 30, a second metal film (second conductive film), a second interlayer insulating film (second insulating film) 31, a flattening film (second insulating film) 32, a third metal film (third conductive film), a third interlayer insulating film 33, a first transparent electrode film, and an alignment film are formed layered in order from the lower layer side (glass substrate 21GS side).

Each of the first metal film, the second metal film, and the third metal film is a single-layer film made of one type of metal material, or a layered film or alloy made of different types of metal materials, and thus has electrical conductivity. The first metal film constitutes the gate wiring line 26, the gate electrode 24A of the TFT 24, and the like. The second metal film constitutes the source wiring line 27, the source electrode 24B and the drain electrode 24C of the TFT 24, and the like. The third metal film constitutes a gate lead-out wiring line 34 to be described below, and the like.

The semiconductor film is made of a crystalline polysilicon semiconductor material (semiconductor material) created by a known method such as laser crystallization. The polysilicon semiconductor material of the semiconductor film has a higher electron mobility than that of an amorphous silicon semiconductor material or an oxide semiconductor material. The semiconductor film constitutes the semiconductor portion 24D of the TFT 24, and the like. The base coat film 28, the gate insulating film 29, the first interlayer insulating film 30, the second interlayer insulating film 31, and the third interlayer insulating film 33 are all made of inorganic materials (inorganic resin materials) such as SiO₂ (silicon oxide) and SiNₓ (silicon nitride). The flattening film 32 is made of an organic material such as PMMA (acrylic resin). The film thickness of the flattening film 32 is far greater than the film thicknesses of the base coat film 28, the gate insulating film 29, the first interlayer insulating film 30, the second interlayer insulating film 31, and the third interlayer insulating film 33. The flattening film 32 flattens the inner face of the array substrate 21 (the surface on the liquid crystal layer 22 side). The base coat film 28 is located on the lower layer side of the semiconductor film. The gate insulating film 29 is interposed between the semiconductor film and the first metal film. The first interlayer insulating film 30 is interposed between the first metal film and the second metal film. The second interlayer insulating film 31 and the flattening film 32 are interposed between the second metal film and the third metal film. The third interlayer insulating film 33 is interposed between the third metal film and the first transparent electrode film.

As illustrated in FIG. 4, in the TFT 24, the gate electrode 24A constituted by a part of the first metal film is located on the upper layer side with respect to the semiconductor portion 24D constituted by a part of the semiconductor film with the gate insulating film 29 interposed therebetween. That is, the TFT 24 can be said to be a top-gate transistor. The source electrode 24B and the drain electrode 24C constituted by a part of the second metal film are disposed at positions spaced apart from each other at a predetermined interval, and the parts thereof are connected to the semiconductor portion 24D through a pair of first pixel contact holes CH1 formed in communication with the gate insulating film 29 and the first interlayer insulating film 30. The pixel electrode 25 constituted by a part of the first transparent electrode film is connected to the drain electrode 24C through a second pixel contact hole CH2 formed in communication with the second interlayer insulating film 31, the flattening film 32, and the third interlayer insulating film 33.

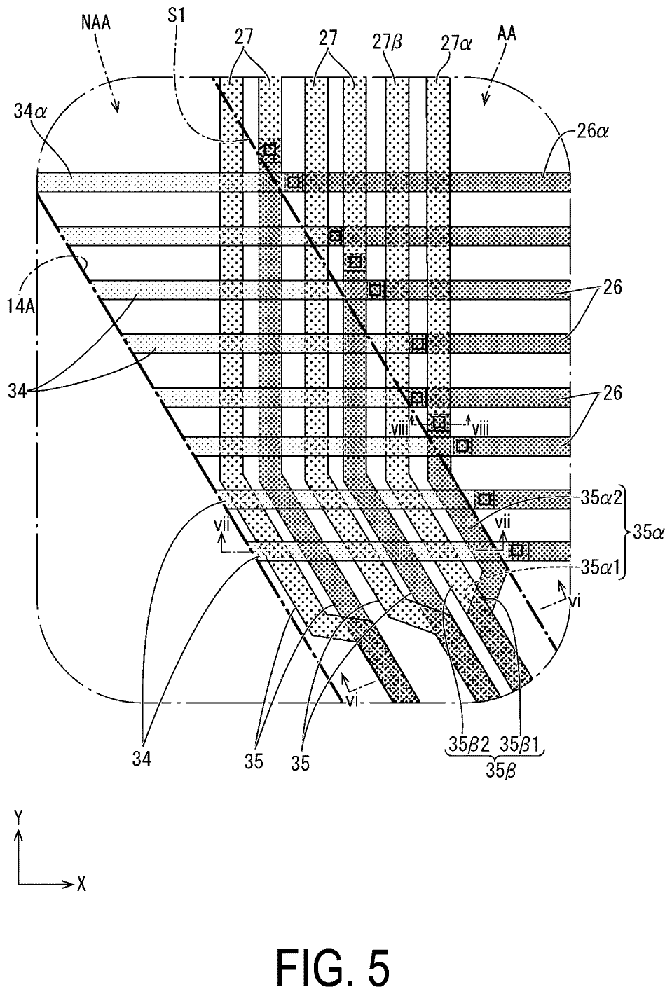

As illustrated in FIG. 5, on the inner face side of the array substrate 21 in the non-display region NAA, there are provided the gate lead-out wiring line 34 connected to the gate drive circuit 14 and the gate wiring line 26, and a source lead-out wiring line 35 connected to the driver 12 and the source wiring line 27. The gate lead-out wiring line 34 is disposed in a region of the non-display region NAA between the gate drive circuit 14 and the display region AA in the X-axis direction. The gate lead-out wiring line 34 extends substantially in the X-axis direction and is configured such that one end is connected to the gate drive circuit 14 and the other end is connected to the gate wiring line 26. The number of gate lead-out wiring lines 34 provided is the same as the number of gate wiring lines 26. It can be said that the gate wiring line 26 is connected to the gate drive circuit 14 via the gate lead-out wiring line 34.

As illustrated in FIG. 5, the source lead-out wiring line 35 is routed to spread out substantially in a fan shape from the driver 12 side toward the display region AA, and is appropriately bent partway thereof. One end of the source lead-out wiring line 35 is connected to a terminal portion connected to the driver 12, and the other end is connected to the source wiring line 27. The number of source lead-out wiring lines 35 provided is the same as the number of source wiring lines 27. It can be said that the source wiring line 27 is connected to the driver 12 via the source lead-out wiring line 35.

A routing path and a wiring line length of the source lead-out wiring line 35 vary depending on the source wiring line 27 to be connected, as illustrated in FIG. 5. Specifically, there are two types of source wiring lines 27, that is, one in which an end connected to the source lead-out wiring line 35 is disposed near the first parallel side portion P1 in the display region AA and is orthogonal to the first parallel side portion P1, and one in which an end connected to the source lead-out wiring line 35 is disposed near the first inclined side portion S1 in the display region AA and intersects the first inclined side portion S1. Of these, the source lead-out wiring line 35 connected to the former source wiring line 27 is routed from the terminal portion connected to the driver 12 to the vicinity of the first parallel side portion P1, whereas the source lead-out wiring line 35 connected to the latter source wiring line 27 is routed from the terminal portion connected to the driver 12 to the vicinity of the first inclined side portion S1. Thus, the source lead-out wiring line 35 routed from the terminal portion connected to the driver 12 to the vicinity of the first inclined side portion S1 extends in the Y-axis direction toward the side opposite to the driver 12 side (the second parallel side portion P2 side) from the first parallel side portion P1, and the extending portion is disposed being interposed between the first gate drive circuit 14A and the first inclined side portion S1. For this reason, a space is required between the first gate drive circuit 14A and the first inclined side portion S1 to dispose the plurality of source lead-out wiring lines 35, which leads to a concern that the frame width near the first inclined side portion S1 will become wider. Furthermore, the source lead-out wiring lines 35 routed from the terminal portion connected to the driver 12 to the vicinity of the first inclined side portion S1 have a longer wiring line length than the source lead-out wiring lines 35 routed from the terminal portion connected to the driver 12 to the vicinity of the first parallel side portion P1. For this reason, there is a concern that the source lead-out wiring lines 35 routed from the terminal portion connected to the driver 12 to the vicinity of the first inclined side portion S1 will have a high wiring line resistance, making it easier for distortion of a transmitted image signal to occur.

Here, among the plurality of source wiring lines 27 each in which the end connected to the source lead-out wiring line 35 is disposed near the first inclined side portion S1 in the display region AA, one source wiring line 27 is referred to as a “first source wiring line (first wiring line) 27α”, and another source wiring line 27 other than the first source wiring line 27α is referred to as a “second source wiring line (second wiring line) 27B”. Among the plurality of source lead-out wiring lines 35 routed from the terminal portion connected to the driver 12 to the vicinity of the first inclined side portion S1, a source lead-out wiring line 35 connected to the first source wiring line 27α is referred to as a “first source lead-out wiring line (third wiring line) 35α”, and a source lead-out wiring line 35 connected to the second source wiring line 27β is referred to as a “second source lead-out wiring line (fourth wiring line) 35β”. Further, among the plurality of gate wiring lines 26 connected to the first gate drive circuit 14A via the gate lead-out wiring line 34, one gate wiring line 26 is referred to as a “first gate wiring line (fifth wiring line) 26α”. Furthermore, among the plurality of gate lead-out wiring lines 34, a gate lead-out wiring line 34 connected to the first gate wiring line 26α is referred to as a “first gate lead-out wiring line (seventh wiring line) 34α”.

In present embodiment, the first source lead-out wiring line 35α is constituted by the first metal film, and the second source lead-out wiring line 35β is constituted by a part of the second metal film. In FIG. 5, a configuration constituted by a part of the first metal film, a configuration constituted by a part of the second metal film, and a configuration constituted by a part of the third metal film are illustrated in different shaded forms. The first source lead-out wiring line 35α and the second source lead-out wiring line 35β are disposed partially overlapping each other, as illustrated in FIGS. 5 to 7. Specifically, the first source lead-out wiring line 35α includes a first wiring line portion 35α1 that overlaps a part (third wiring line portion 35β1) of the second source lead-out wiring line 35β, and a second wiring line portion 35α2 that does not overlap the second source lead-out wiring line 35B. The second source lead-out wiring line 35β includes a third wiring line portion 35β1 that overlaps a part (first wiring line portion 35α1) of the first source lead-out wiring line 35α, and a fourth wiring line portion 35β2 that does not overlap the first source lead-out wiring line 35α.

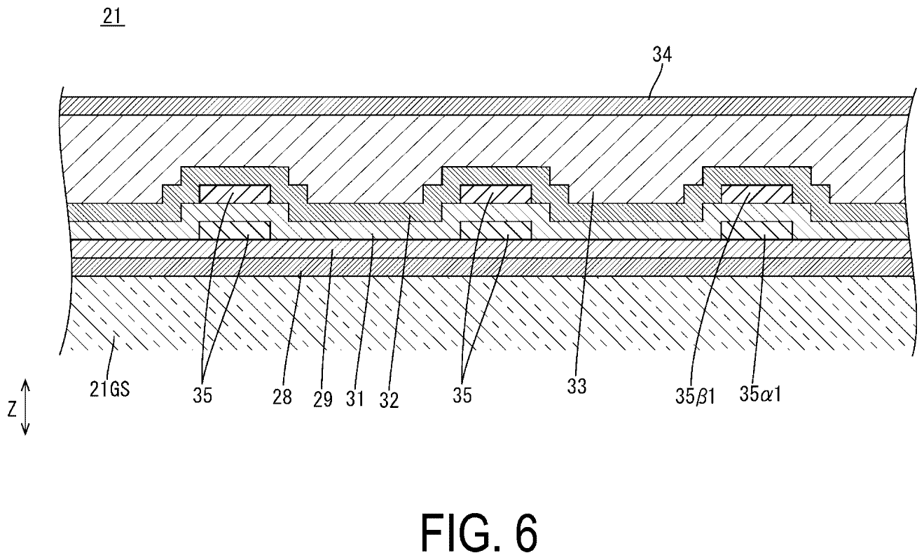

As illustrated in FIG. 5, the first wiring line portion 35α1 has one end connected to the terminal portion connected to the driver 12, and the other end connected to the second wiring line portion 35α2. The third wiring line portion 35β1 has one end connected to the terminal portion connected to the driver 12, and the other end connected to the fourth wiring line portion 35β2. The first wiring line portion 35α1, which is constituted by a part of the first metal film, is disposed overlapping the third wiring line portion 35β1, which is constituted by a part of the second metal film, via the first interlayer insulating film 30, as illustrated in FIG. 6. The first wiring line portion 35α1 and the third wiring line portion 35β1, which overlap each other, are kept in an insulated state by the first interlayer insulating film 30. In this manner, since the first wiring line portion 35α1 and the third wiring line portion 35β1 are disposed overlapping each other, a space required for routing the first source lead-out wiring line 35α and the second source lead-out wiring line 35B can be reduced. Thereby, it is possible to narrow a gap that has to be provided between the first inclined side portion S1 and the gate drive circuit 14, thereby making it possible to achieve a narrow frame near the first inclined side portion S1.

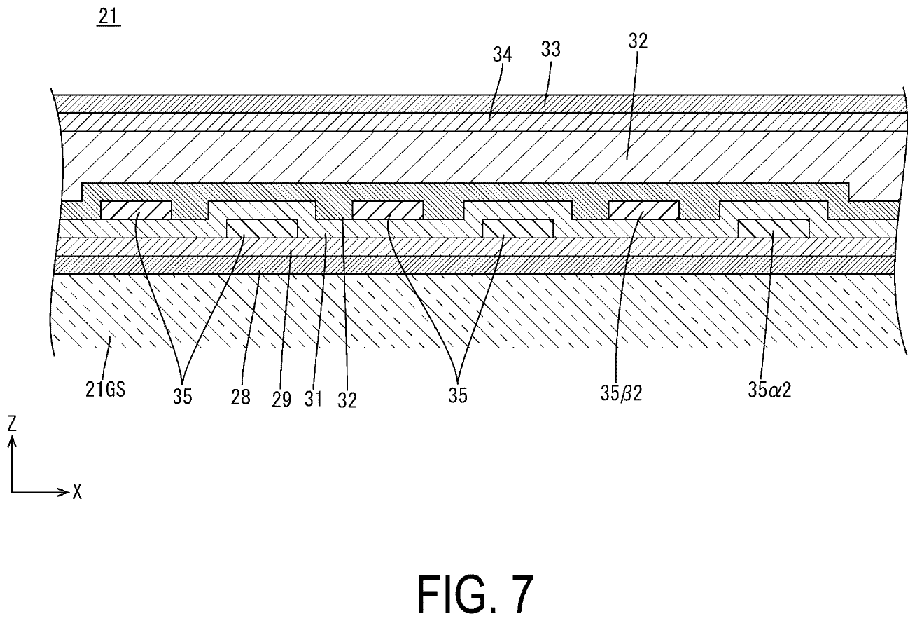

As illustrated in FIG. 5, the second wiring line portion 35α2 has one end connected to the first wiring line portion 35α1 and the other end connected to the first source wiring line 27α. The fourth wiring line portion 35β2 has one end connected to the third wiring line portion 35β1 and the other end connected to the second source wiring line 27β. As illustrated in FIG. 7, the second wiring line portion 35α2 and the fourth wiring line portion 35β2 are disposed not to overlap each other, and thus it is possible to reduce parasitic capacitance that may occur between the first source lead-out wiring line 35α and the second source lead-out wiring line 35β. Thereby, distortion is less likely to occur in image signals supplied from the driver 12 to the first source lead-out wiring line 35α and the second source lead-out wiring line 35β. Since the first interlayer insulating film 30 is interposed between the second wiring line portion 35α2 constituted by a part of the first metal film and the fourth wiring line portion 35β2 constituted by a part of the second metal film, a short circuit is less likely to occur even when an arrangement pitch between the second wiring line portion 35α2 and the fourth wiring line portion 35β2 becomes narrower.

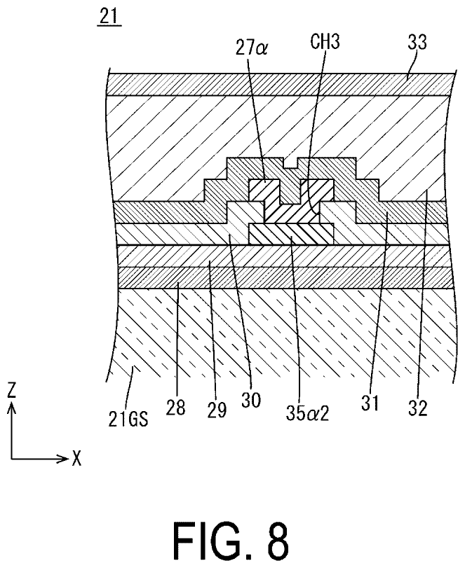

As illustrated in FIG. 8, the other end of the second wiring line portion 35α2 constituted by a part of the first metal film is disposed overlapping an end of the first source wiring line 27α constituted by a part of the second metal film. A first wiring line contact hole CH3 is formed in the first interlayer insulating film 30 interposed between the second wiring line portion 35α2 and the first source wiring line 27α. The overlapping portions of the second wiring line portion 35α2 and the first source wiring line 27α are connected to each other through the first wiring line contact hole CH3. The fourth wiring line portion 35β2 constituted by a part of the second metal film is connected to be directly continuous with the second source wiring line 27β constituted by a part of the second metal film. In addition, the first wiring line portion 35α1 constituted by a part of the first metal film is connected to be directly continuous with the second wiring line portion 35α2 constituted by a part of the first metal film. The third wiring line portion 35β1 constituted by a part of the second metal film is connected to be directly continuous with the fourth wiring line portion 35β2 constituted by a part of the second metal film.

As illustrated in FIG. 5, a boundary position between the first wiring line portion 35α1 and the second wiring line portion 35α2 of the first source lead-out wiring line 35α is disposed on a side opposite to the driver 12 side from the first parallel side portion P1 in the Y-axis direction. Similarly, a boundary position between the third wiring line portion 35β1 and the fourth wiring line portion 35β2 of the second source lead-out wiring line 35β is disposed on a side opposite to the driver 12 side from the first parallel side portion P1 in the Y-axis direction. That is, the first wiring line portion 35α1 and the third wiring line portion 35β1 extend to a side opposite to the driver 12 side from the first parallel side portion P1 in the Y-axis direction. In this manner, the first wiring line portion 35α1 and the third wiring line portion 35β1, which overlap each other, are disposed in the non-display region NAA on a side opposite to the driver 12 side from the first parallel side portion P1 in the Y-axis direction. Thereby, it is possible to preferably achieve a narrow frame near the first inclined side portion S1. More specifically, the length dimension of the second wiring line portion 35α2 is approximately half a distance on the first inclined side portion S1 from the end of the first inclined side portion S1 on the first parallel side portion P1 side to an intersection position between the first source wiring line 27α and the first inclined side portion S1. Similarly, the length dimension of the fourth wiring line portion 35β2 is approximately half a distance on the first inclined side portion S1 from the end of the first inclined side portion S1 on the first parallel side portion P1 side to an intersection position between the second source wiring line 27B and the first inclined side portion S1.

As illustrated in FIG. 5, the first gate lead-out wiring line 34α extends in the X-axis direction and is configured such that one end is connected to the first gate drive circuit 14A and the other end is connected to the first gate wiring line 26α. The first gate lead-out wiring line 34α is in an intersection relationship with the second wiring line portion 35α2 and the fourth wiring line portion 35β2. As illustrated in FIG. 7, the first gate lead-out wiring line 34α is constituted by a third metal film and is configured such that the first interlayer insulating film 30, the second interlayer insulating film 31, and the flattening film 32 are interposed between the first gate lead-out wiring line 34α and the intersecting second wiring line portion 35α2, and the second interlayer insulating film 31 and the flattening film 32 are interposed between the first gate lead-out wiring line 34α and the intersecting fourth wiring line portion 35β2. Thereby, the first gate lead-out wiring line 34α is prevented from being short-circuited with the first source lead-out wiring line 35α and the second source lead-out wiring line 35β. In the first gate lead-out wiring line 34α which is constituted by a part of the third metal film, the other end is disposed overlapping an end of the first gate wiring line 26α which is constituted by a part of the first metal film. Contact holes for connecting the first gate lead-out wiring line 34α and the first gate wiring line 26α are formed in the first interlayer insulating film 30, the second interlayer insulating film 31, and the flattening film 32 interposed between the first gate lead-out wiring line 34α and the first gate wiring line 26α.

As described above, the array substrate (display substrate) 21 of present embodiment includes the display region AA where an image is displayed, the non-display region NAA where an image is not displayed, the driver (first signal supply unit) 12 disposed in the non-display region NAA at a position spaced apart from the display region AA in the first direction, the first source wiring line (first wiring line) 27α disposed in the display region AA and extending in the first direction, the second source wiring line (second wiring line) 27β disposed in the display region AA and extending in the first direction, the first source lead-out wiring line (third wiring line) 35α disposed in the non-display region NAA and connected to the driver 12 and the first source wiring line 27α, and the second source lead-out wiring line (fourth wiring line) 35β disposed in the non-display region NAA and connected to the driver 12 and the second source wiring line 27B. The outer peripheral side portion in the display region AA includes the first inclined side portion S1 that is inclined in the first direction such that a distance from the driver 12 increases toward the end side in the second direction orthogonal to the first direction. The first source wiring line 27α and the second source wiring line 27β are both disposed intersecting the first inclined side portion S1. The first source lead-out wiring line 35α includes the first wiring line portion 35α1 constituted by a part of the first metal film (first conductive film) and the second wiring line portion 35α2 constituted by a part of the first metal film or the second metal film (second conductive film) with the first interlayer insulating film (first insulating film) 30 interposed between the first metal film and the second metal film. The second wiring line portion 35α2 is connected to the first wiring line portion 35α1 and the first source wiring line 27α. The second source lead-out wiring line 35β includes the third wiring line portion 35β1 constituted by a part of the second metal film, and the fourth wiring line portion 35β2 constituted by a part of the first metal film or the second metal film. The third wiring line portion 35β1 is disposed overlapping the first wiring line portion 35α1. The fourth wiring line portion 35β2 is disposed not to overlap the second wiring line portion 35α2 and is connected to the third wiring line portion 35β1 and the second source wiring line 27B.

The first source lead-out wiring line 35α and the second source lead-out wiring line 35β disposed in the non-display region NAA are connected to the first source wiring line 27α and the second source wiring line 27B that intersect the first inclined side portion S1 in the display region AA. For this reason, it is necessary to secure a space for routing the first source lead-out wiring line 35α and the second source lead-out wiring line 35β near the first inclined side portion S1 of the non-display region NAA, which leads to a problem that the frame tends to become wider near the first inclined side portion S1. In this regard, the third wiring line portion 35β1 constituting the second source lead-out wiring line 35β and constituted by a part of the second metal film is disposed overlapping the first wiring line portion 35α1 constituting the first source lead-out wiring line 35α and constituted by a part of the first metal film via the first interlayer insulating film 30, and thus it is possible to reduce a space for routing the first source lead-out wiring line 35α and the second source lead-out wiring line 35β. Thereby, it is possible to achieve a narrow frame near the first inclined side portion S1.

Furthermore, the fourth wiring line portion 35β2 that constitutes the second source lead-out wiring line 35β and is connected to the third wiring line portion 35β1 and the second source wiring line 27B is disposed not to overlap the second wiring line portion 35α2 that constitutes the first source lead-out wiring line 35α and is connected to the first wiring line portion 35α1 and the first source wiring line 27α, and thus it is possible to reduce parasitic capacitance that may occur between the first source lead-out wiring line 35α and the second source lead-out wiring line 35β. Thereby, distortion is less likely to occur in signals supplied from the driver 12 to the first source lead-out wiring line 35α and the second source lead-out wiring line 35β.

In addition, the first gate wiring line (fifth wiring line) 26α disposed in the display region AA and extending in the second direction, and the first gate drive circuit (second signal supply unit) 14A disposed in the non-display region NAA and connected to the first gate wiring line 26α to supply a signal to the first gate wiring line 26α are provided. The first gate drive circuit 14A extends along the first inclined side portion S1 and is disposed at a position spaced apart from the first inclined side portion S1. The first source lead-out wiring line 35α and the second source lead-out wiring line 35β are disposed being interposed between the first inclined side portion S1 and the first gate drive circuit 14A. A signal is supplied to the first gate wiring line 26α in the display region AA from the first gate drive circuit 14A. The first source lead-out wiring line 35α and the second source lead-out wiring line 35β can be disposed in the space formed between the first inclined side portion S1 and the first gate drive circuit 14A in the display region AA. A space for routing the first source lead-out wiring line 35α and the second source lead-out wiring line 35β is reduced due to the first wiring line portion 35α1 and the third wiring line portion 35β1 being disposed overlapping each other, and thus a gap between the first inclined side portion S1 in the display region AA and the first gate drive circuit 14A can be narrowed, thereby making it possible to achieve a narrow frame near the first inclined side portion S1.

In addition, the outer peripheral side portion in the display region AA includes he first parallel side portion P1 that is continuous with the end of the first inclined side portion S1 on the driver 12 side and is parallel to the second direction, and the first wiring line portion 35α1 and the third wiring line portion 35β1 extend to a side opposite to the driver 12 side from the first parallel side portion P1 in the first direction. In this manner, the first wiring line portion 35α1 and the third wiring line portion 35β1 that overlap each other are disposed in the non-display region NAA on a side opposite to the driver 12 side from the first parallel side portion P1 in the first direction. Thereby, it is possible to preferably achieve a narrow frame near the first inclined side portion S1.

Furthermore, the liquid crystal panel (display device) 11 according to present embodiment includes the array substrate 21 described above and the counter substrate 20 disposed facing the array substrate 21. It is possible to achieve a narrow frame of the liquid crystal panel 11.

### Second Embodiment

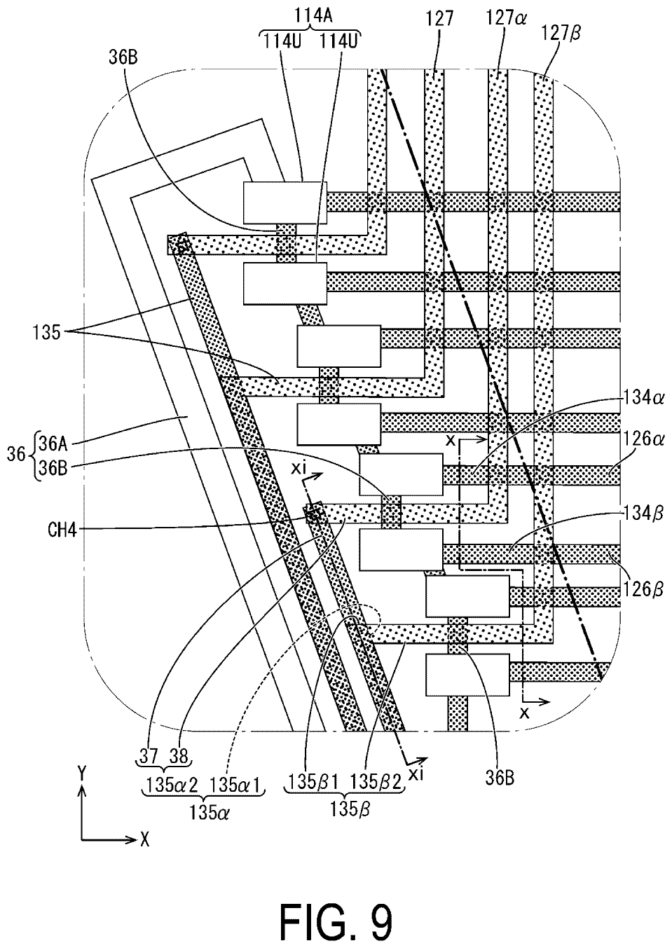

A second embodiment will be described with reference to FIGS. 9 to 11. The second embodiment shows a case where the arrangement of a first gate drive circuit 114A and a source lead-out wiring line 135 is changed, and the configuration of a first source lead-out wiring line 135α is changed. Repeated descriptions of structures, actions, and effects similar to those of the first embodiment described above will be omitted.

The first gate drive circuit 114A according to present embodiment is disposed adjacent to a first inclined side portion S1, as illustrated in FIG. 9. A plurality of source lead-out wiring lines 135 (including a first source lead-out wiring line 135α and a second source lead-out wiring line 135β) that are routed from a terminal portion connected to a driver 12 (see FIG. 1) to the vicinity of a first parallel side portion P101 are all disposed sandwiching the first gate drive circuit 114A between them and a first inclined side portion S101 in the display region AA. In this manner, the first source lead-out wiring line 135α and the second source lead-out wiring line 135B are disposed in a space secured on a side opposite to the first inclined side portion S101 in the display region AA with respect to the first gate drive circuit 114A. As described in the first embodiment, the first wiring line portion 135α1 and the third wiring line portion 135β1 are disposed overlapping each other, thereby reducing a space for routing the first source lead-out wiring line 135α and the second source lead-out wiring line 135β. Thus, it is possible to reduce a space required to dispose the plurality of source lead-out wiring lines 135 on a side opposite to the first inclined side portion S101 side in the display region AA with respect to the first gate drive circuit 114A. Thereby, it is possible to achieve a narrow frame near the first inclined side portion S101.

FIG. 9 illustrates a plurality of unit gate circuit portions (unit first signal supply circuits) 114U constituting the first gate drive circuit 114A. The plurality of unit gate circuit portions 114U are disposed side by side at intervals along the first inclined side portion S101 in the display region AA. The unit gate circuit portions 114U adjacent to each other in a direction along the first inclined side portion S101 are connected to each other by a gate drive wiring line (ninth wiring line) 36. The gate drive wiring line 36 is routed from a terminal portion connected to a flexible substrate 13 (see FIG. 1) in the non-display region NAA to the unit gate circuit portion 114U located at the uppermost stage among the plurality of unit gate circuit portions 1140, and then crosses all of the unit gate circuit portions 114U from the unit gate circuit portion 114U located at the uppermost stage to the unit gate circuit portion 114U located at the lowermost stage. The gate drive wiring line 36 includes a gate start pulse wiring line, a clock wiring line, a power supply voltage wiring line, and the like. On the basis of various signals transmitted by the gate drive wiring line 36, scanning signals are output from the plurality of unit gate circuit portions 114U to the plurality of gate lead-out wiring lines 134 in order from the upper stage side.

As illustrated in FIG. 9, the gate drive wiring line 36 generally extends along the first inclined side portion S101 in the non-display region NAA. The gate drive wiring line 36 is disposed such that a first drive wiring line portion 36A, which is a portion extending from the terminal portion connected to the flexible substrate 13 to the unit gate circuit portion 114U located at the uppermost stage, sandwiches the plurality of source lead-out wiring lines 135 (including the first source lead-out wiring line 135α and the second source lead-out wiring line 135β) between the first drive wiring line portion 36A and the first gate drive circuit 114A. Thus, the first drive wiring line portion 36A is prevented from crossing the plurality of source lead-out wiring lines 135. Thus, regardless of whether the first drive wiring line portion 36A is constituted by the first metal film, the second metal film, or the third metal film, it is possible to avoid a short circuit with the source lead-out wiring line 135. Thereby, the degree of freedom of the type of metal film used for the first drive wiring line portion 36A is increased. Further, the gate drive wiring line 36 is configured such that a second drive wiring line portion 36B, which is a portion extending from the unit gate circuit portion 114U located at the uppermost stage to the unit gate circuit portion 114U located at the lowermost stage, is constituted by a part of the first metal film.

In present embodiment, the first source lead-out wiring line 135α and the second source lead-out wiring line 135β are both disposed sandwiching the first gate drive circuit 114A between themselves and the first inclined side portion S101 in the display region AA. For this reason, the second wiring line portion 135α2 of the first source lead-out wiring line 135α crosses the second drive wiring line portion 36B and the gate lead-out wiring line 134 on the way to a first source wiring line 127α to be connected. Similarly, a fourth wiring line portion 135β2 of the second source lead-out wiring line 135β crosses the second drive wiring line portion 36B and the gate lead-out wiring line 134 on the way to a second source wiring line 127 to be connected. Here, among the plurality of gate wiring lines 126 connected to the first gate drive circuit 114A via the gate lead-out wiring line 134, the gate wiring line 126 that intersects the second wiring line portion 135α2 is referred to as a “first gate wiring line (fifth wiring line) 126α”, and the gate wiring line 126 that intersects the fourth wiring line portion 135β2 is referred to as a “second gate wiring line (sixth wiring line) 126B”. Furthermore, among the plurality of gate lead-out wiring lines 134, the gate lead-out wiring line 134 connected to the first gate wiring line 126α is referred to as a “first gate lead-out wiring line (seventh wiring line) 134α”, and the gate lead-out wiring line 134 connected to the second gate wiring line 126β is referred to as a “second gate lead-out wiring line (eighth wiring line) 134β”.

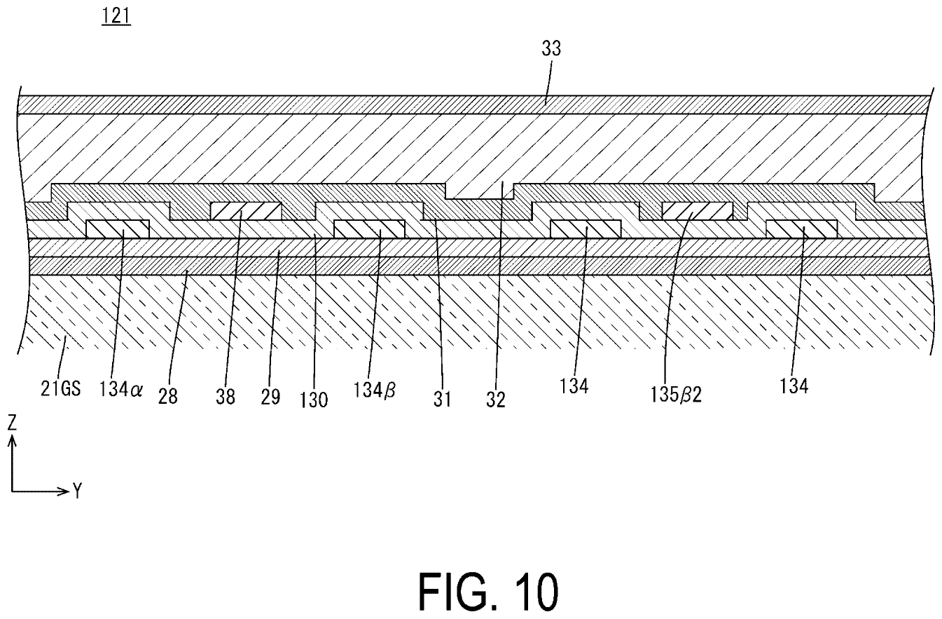

In present embodiment, each of the plurality of gate lead-out wiring lines 134 is constituted by a part of the first metal film, as illustrated in FIGS. 9 and 10. Thus, the fourth wiring line portion 135β2 constituted by a part of the second metal film intersects the second gate lead-out wiring line 134β via a first interlayer insulating film 130. The first interlayer insulating film 130 is interposed between the fourth wiring line portion 135β2 and the second gate lead-out wiring line 134β, which intersect each other, thereby preventing a short circuit therebetween.

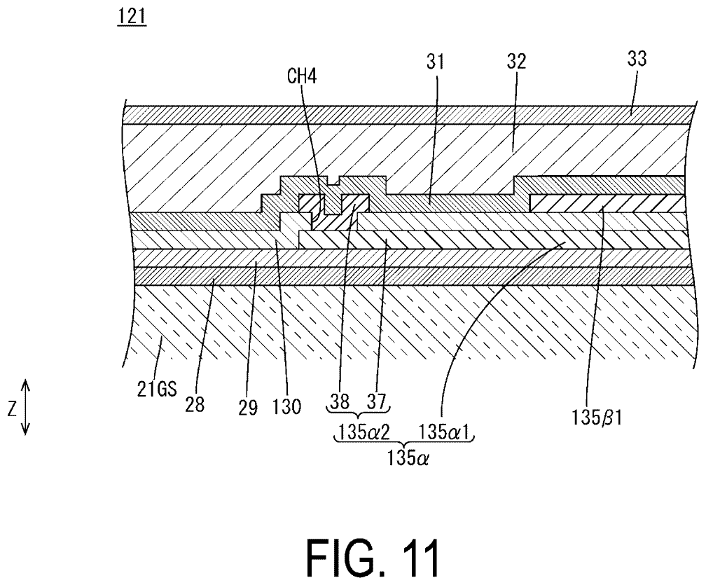

On the other hand, as illustrated in FIGS. 9 and 11, the second wiring line portion 135α2 is configured by connecting a first metal film portion (first conductive film portion) 37 constituted by a part of the first metal film, and a second metal film portion (second conductive film portion) 38 constituted by a part of the second metal film. In detail, the first metal film portion 37 is connected to the other end of the first wiring line portion 135α1 constituted by a part of the first metal film, and extends in parallel with the first wiring line portion 135α1 (first inclined side portion S101). The second metal film portion 38 is configured by connecting a portion that extends in the X-axis direction and intersects the first metal film portion 37 and a portion that extends in the Y-axis direction. The portion of the second metal film portion 38 which extends in the X-axis direction has an end overlapping an end of the first metal film portion 37, and is disposed being interposed between two unit gate circuit portions 114U adjacent in the Y-axis direction. The portion of the second metal film portion 38 which extends in the X-axis direction and the first metal film portion 37 have their ends overlapping each other, and are connected to each other through a first contact hole CH4 formed in the first interlayer insulating film 130 interposed therebetween. The portion of the second metal film portion 38 which extends in the Y-axis direction has an end connected to the first source wiring line 127α to be connected, and intersects the first gate lead-out wiring line 134α constituted by a part of the first metal film. The first interlayer insulating film 130 is interposed between the second metal film portion 38 and the first gate lead-out wiring line 134α, which intersect each other, thereby preventing a short circuit therebetween. In present embodiment, the first metal film and the second metal film can constitute the wiring lines 134α and 134β and the wiring line portions 36B, 135α1, 135α2, 135β1, and 1352. Thereby, the array substrate 121 does not include the third metal film and third interlayer insulating film 33 (see FIG. 6) described in the first embodiment. That is, according to present embodiment, the number of metal films provided on the array substrate 121 may be smaller than that in the first embodiment.

As described above, according to present embodiment, the first gate wiring line 126α disposed in the display region AA and extending in the second direction, and the first gate drive circuit 114A disposed in the non-display region NAA and supplying a signal to the first gate wiring line 126α are provided. The first gate drive circuit 114A extends along the first inclined side portion S101 and is disposed adjacent to the first inclined side portion S101. The first source lead-out wiring line 135α and the second source lead-out wiring line 135β are disposed sandwiching the first gate drive circuit 114A between them and the first inclined side portion S101. A signal is supplied to the first gate wiring line 126α in the display region AA from the first gate drive circuit 114A. The first source lead-out wiring line 135α and the second source lead-out wiring line 135β can be disposed in a space secured on a side opposite to the first inclined side portion S1 in the display region AA with respect to the first gate drive circuit 114A. A space for routing the first source lead-out wiring line 135α and the second source lead-out wiring line 135B is reduced due to the first wiring line portion 135α1 and the third wiring line portion 135β1 being disposed overlapping each other, and thus a space required on a side opposite to the first inclined side portion S101 side in the display region AA with respect to the first gate drive circuit 114A can be narrowed, thereby making it possible to achieve a narrow frame near the first inclined side portion S101.

In addition, the second gate wiring line (sixth wiring line) 126β disposed in the display region AA and extending in the second direction, the first gate lead-out wiring line (seventh wiring line) 134α disposed in the non-display region NAA and connected to the first gate wiring line 126α and the first gate drive circuit 114A, and the second gate lead-out wiring line (eighth wiring line) 134β disposed in the non-display region NAA and connected to the second gate wiring line 126β and the first gate drive circuit 14A are provided. The first gate wiring line 126α, the second gate wiring line 126β, the first gate lead-out wiring line 134α, the second gate lead-out wiring line 134β, and the first wiring line portion 135α1 are each constituted by a part of the first metal film. The first source wiring line 127α, the second source wiring line 127B, the third wiring line portion 1351, and the fourth wiring line portion 13532 are each constituted by a part of the second metal film. The fourth wiring line portion 1352 intersects the second gate lead-out wiring line 134β through the first interlayer insulating film 130. The second wiring line portion 135α2 connects the first metal film portion (first conductive film portion) 37 constituted by a part of the first metal film and the second metal film portion (second conductive film portion) 38 constituted by a part of the second metal film through the first contact hole CH4 formed in the first interlayer insulating film 130. The second metal film portion 38 intersects the first gate lead-out wiring line 134α through the first interlayer insulating film 130. In this manner, the first source lead-out wiring line 135α and the second source lead-out wiring line 135β can be prevented from being short-circuited with the first gate lead-out wiring line 134α and the second gate lead-out wiring line 134B. Since the first metal film and the second metal film can constitute the wiring lines 134α and 134β and the wiring line portions 36B, 135α1, 135α2, 135β1, and 135β2, the number of metal films (conductive films) provided on the array substrate 121 can be reduced.

In addition, gate drive wiring line (ninth wiring line) 36 disposed in the non-display region NAA and connected to the first gate drive circuit 114A is provided, and the gate drive wiring line 36 extends along the first inclined side portion S101 and is disposed sandwiching the first source lead-out wiring line 135α and the second source lead-out wiring line 135β between the gate drive wiring line 36 and the first gate drive circuit 114A. Various signals can be supplied to the first gate drive circuit 114A by the gate drive wiring line 36. A space for routing the first source lead-out wiring line 135α and the second source lead-out wiring line 135B is reduced due to the first wiring line portion 135α1 and the third wiring line portion 1351 being disposed overlapping each other, and thus it is possible to secure a sufficient space for disposing the gate drive wiring line 36 on the first gate drive circuit 114A side with respect to the first source lead-out wiring line 135α and the second source lead-out wiring line 135β.

### Third Embodiment

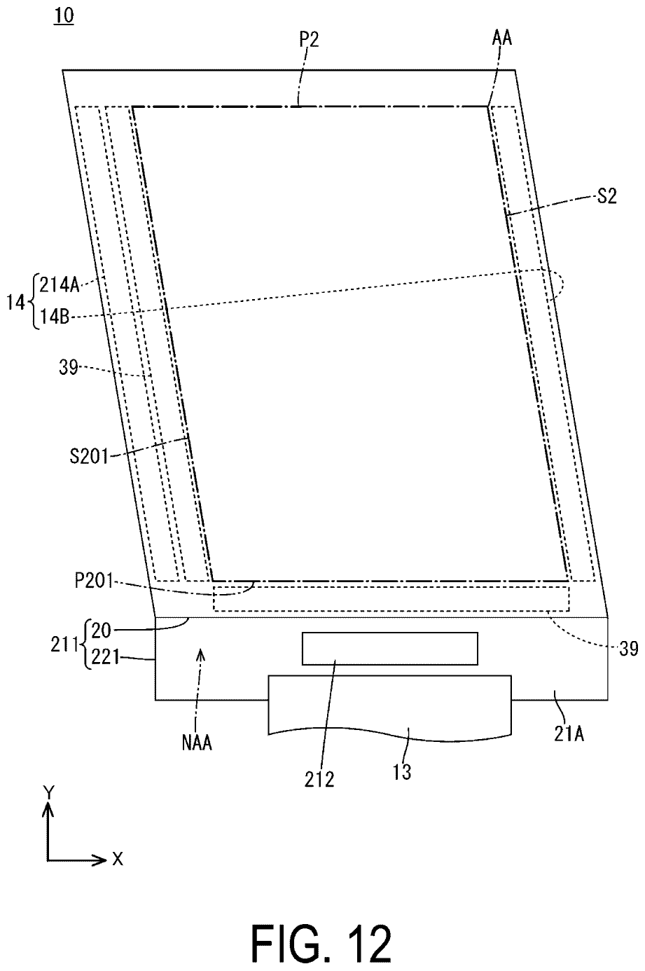

A third embodiment will be described with reference to FIGS. 12 to 14. The third embodiment shows a case where a switch circuit 39 is added to the first embodiment. Repeated descriptions of structures, actions, and effects similar to those of the first embodiment described above will be omitted.

As illustrated in FIG. 12, an array substrate 221 according to present embodiment is provided with the switch circuit 39. The switch circuit 39 has a switch function of distributing image signals, which are supplied from a driver 212, to a source wiring line 227. The switch circuit 39 is a so-called source shared driving (SSD) circuit. The switch circuit 39 is disposed in a non-display region NAA at a position adjacent to a first parallel side portion P201 and a first inclined side portion S201 in a display region AA, and is provided in a band-shaped range extending along the first parallel side portion P201 and the first inclined side portion S201.

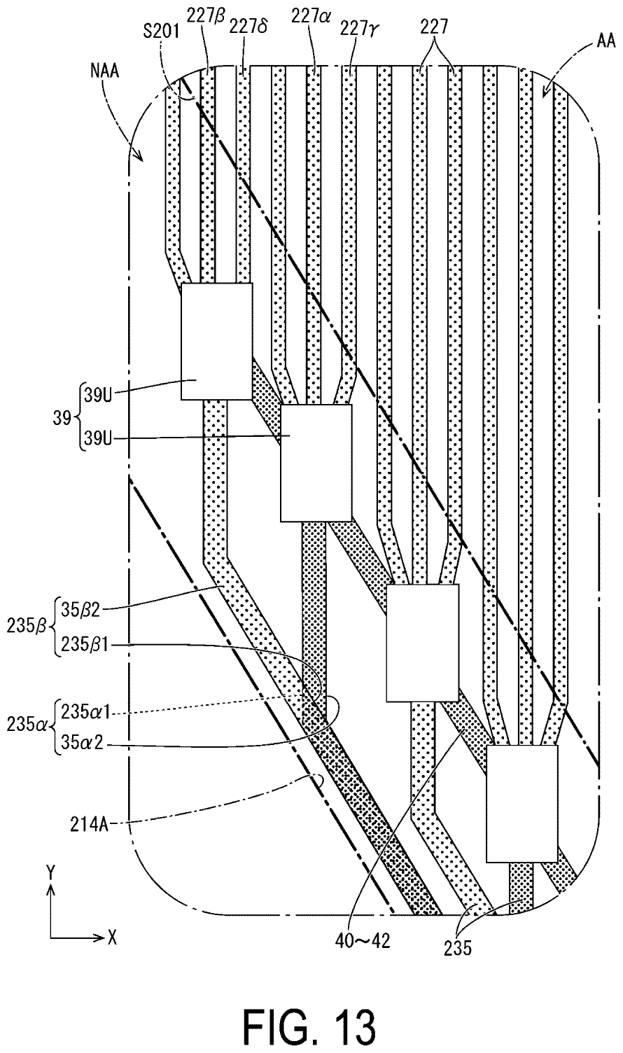

As illustrated in FIG. 13, the switch circuit 39 includes a plurality of unit switch circuit portions 39U. Among the plurality of unit switch circuit portions 39U, the plurality of unit switch circuit portions 39U disposed adjacent to the first inclined side portion S201 are disposed side by side along the first inclined side portion S201. Similarly, the plurality of unit switch circuit portions 39U disposed adjacent to the first parallel side portion P201 are disposed side by side along the first parallel side portion P201 (X-axis direction) (see FIG. 12). The number of unit switch circuit portions 39U installed is ⅓ of the number of source wiring lines 227 installed. The unit switch circuit portions 39U are connected to three source wiring lines 227 and one source lead-out wiring line 235. That is, in present embodiment, it can be said that the source lead-out wiring line 235 is connected to the plurality of source wiring lines 227 via the switch circuit 39. The unit switch circuit portions 39U can distribute image signals supplied by the source lead-out wiring line 235 to the plurality of source wiring lines 227.

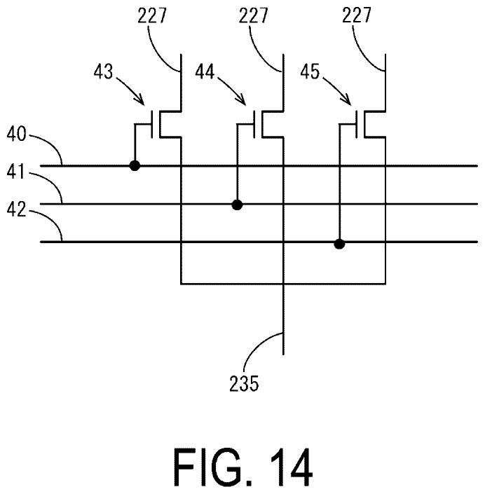

As illustrated in FIG. 14, the switch circuit 39 includes three switch wiring lines 40 to 42 to which switch signals for switching are transmitted. The three switch wiring lines 40 to 42 are disposed at intervals in the Y-axis direction and extend in the arrangement direction of the plurality of unit switch circuit portions 39U to cross all of the unit switch circuit portions 39U. The three switch wiring lines 40 to 42 have their ends extending toward a driver 212 and connected to the driver 212. The three switch wiring lines 40 to 42 are a red switch wiring line 40, a green switch wiring line 41, and a blue switch wiring line 42 in order from the upper side in FIG. 14.

As illustrated in FIG. 14, the unit switch circuit portion 39U includes three switch TFTs 43 to 45 which are connected to the switch wiring lines 40 to 42 and the source wiring line 227 to control the supply of image signals. The three switch TFTs 43 to 45 are a red switch TFT 43, a green switch TFT 44, and a blue switch TFT 45 in order from the left side in FIG. 14. The red switch TFT 43 has a gate electrode connected to the red switch wiring line 40, and a drain electrode connected to the source wiring line 227 that supplies an image signal to a pixel electrode 25 constituting a red pixel. The green switch TFT 44 has a gate electrode connected to the green switch wiring line 41, and a drain electrode connected to the source wiring line 227 that supplies an image signal to the pixel electrode 25 constituting a green pixel. The blue switch TFT 45 has a gate electrode connected to the blue switch wiring line 42 and a drain electrode connected to the source wiring line 227 that supplies an image signal to the pixel electrode 25 constituting a blue pixel. The source electrodes of the switch TFTs 43 to 45 are all connected to the same source lead-out wiring line 235. An end of the source lead-out wiring line 235 on a side opposite to the driver 212 is branched into three parts and connected to the source electrodes of the switch TFTs 43 to 45. The number of source lead-out wiring lines 235 installed is ⅓ of the number of source wiring lines 227 installed. In this manner, compared to a case where source wiring lines are individually connected to source lead-out wiring lines, the number of wiring lines (source lead-out wiring lines 235) provided between the driver 212 and the switch circuit 39 can be reduced to ⅓. Thereby, it is possible to easily route the source lead-out wiring lines 235 even when the frame of the liquid crystal panel 211 becomes narrower.

A red image signal for red pixels, a green image signal for green pixels, and a blue image signal for blue pixels are supplied to the source lead-out wiring line 235 from the driver 212 in a time-division manner. In synchronization with this, a switch signal is supplied from the driver 212 to the three switch wiring lines 40 to 42. Specifically, at a timing when the red image signal is supplied from the driver 212 to the source lead-out wiring line 235, a switch signal is supplied from the driver 212 to the red switch wiring line 40. Thereby, among the three switch TFTs 43 to 45, the red switch TFT 43 is selectively turned on, and thus a red image signal can be supplied to the pixel electrode 25 (see FIG. 3) constituting the red pixel via the selected source wiring line 227. At a timing when a green image signal is supplied to the source lead-out wiring line 235 from the driver 212, a switch signal is supplied from the driver 212 to the green switch wiring line 41. Thereby, among the three switch TFTs 43 to 45, the green switch TFT 44 is selectively turned on, and thus a green image signal can be supplied to the pixel electrode 25 constituting the green pixel via the selected source wiring line 227. At a timing when a blue image signal is supplied to the source lead-out wiring line 235 from the driver 212, a switch signal is supplied from the driver 212 to the blue switch wiring line 42. Thereby, among the three switch TFTs 43 to 45, the blue switch TFT 45 is selectively turned on, and thus a blue image signal can be supplied to the pixel electrode 25 constituting the blue pixel via the selected source wiring line 227. As described above, according to the switch circuit 39, the source wiring line 227 connected to the source lead-out wiring line 235 can be switched in synchronization with the timing when an image signal is supplied from the driver 212 to the source lead-out wiring line 235.

In present embodiment, a first source wiring line 227α is connected to a first source lead-out wiring line 235α via the unit switch circuit portion 39U, and a second source wiring line 227β is connected to a second source lead-out wiring line 235β via the unit switch circuit portion 39U. In the following, the source wiring line 227 that is connected to the first source lead-out wiring line 235α via the unit switch circuit portion 39U and is different from the first source wiring line 227α will be referred to as a “third source wiring line (tenth wiring line) 227γ”, and the source wiring line 227 that is connected to the second source lead-out wiring line 235β via the unit switch circuit portion 39U and is different from the second source wiring line 227β will be referred to as a “fourth source wiring line (eleventh wiring line) 2278”.

As illustrated in FIG. 13, the switch circuit 39 can distribute image signals transmitted by the first source lead-out wiring line 235α to the first source wiring line 227α and the third source wiring line 227γ, and distribute image signals transmitted by the second source lead-out wiring line 235β to the second source wiring line 227B and the fourth source wiring line 2278. In present embodiment, the first source lead-out wiring line 235α and the second source lead-out wiring line 235β are disposed sandwiching the switch circuit 39 between them and the first inclined side portion S201. Thus, the first source lead-out wiring line 235α and the second source lead-out wiring line 235β are disposed on a side opposite to the first inclined side portion S201 side in the display region AA with respect to the switch circuit 39 extending along the first inclined side portion S201. A space for routing the first source lead-out wiring line 235α and the second source lead-out wiring line 235β is reduced due to a first wiring line portion 235α1 and a third wiring line portion 235β1 being disposed overlapping each other, and thus it is possible to narrow a space required on a side opposite to the first inclined side portion S201 in the display region AA with respect to the switch circuit 39. Thereby, it is possible to achieve a narrow frame near the first inclined side portion S201.

Furthermore, a first gate drive circuit 214A extending along the first inclined side portion S201 is disposed at a position spaced apart from the switch circuit 39 as illustrated in FIG. 13. The first source lead-out wiring line 235α and the second source lead-out wiring line 235β are disposed being interposed between the switch circuit 39 and the first gate drive circuit 214A. That is, the first source lead-out wiring line 235α and the second source lead-out wiring line 235β are disposed in a space formed between the switch circuit 39 and the first gate drive circuit 214A. A space for routing the first source lead-out wiring line 235α and the second source lead-out wiring line 235β is reduced due to the first wiring line portion 235α1 and the third wiring line portion 235β1 being disposed overlapping each other, and thus a gap between the switch circuit 39 and the first gate drive circuit 214A can be narrowed, thereby making it possible to achieve a narrow frame near the first inclined side portion S201.

As described above, according to present embodiment, the third source wiring line (tenth wiring line) 227γ and the fourth source wiring line (eleventh wiring line) 2278, which are disposed in the display region AA and extend in a first direction, and the switch circuit 39, which is disposed in the non-display region NAA and is connected to the first source wiring line 227α, the second source wiring line 2278, the first source lead-out wiring line 235α, the second source lead-out wiring line 235β, the third source wiring line 227γ, and the fourth source wiring line 2278, are provided. The switch circuit 39 distributes signals transmitted by the first source lead-out wiring line 235α to the first source wiring line 227α and the third source wiring line 227γ, distributes signals transmitted by the second source lead-out wiring line 235B to the second source wiring line 227 and the fourth source wiring line 2278, extends along the first inclined side portion S201, and is disposed at a position adjacent to the first inclined side portion S201. The first source lead-out wiring line 235α and the second source lead-out wiring line 235β are disposed sandwiching the switch circuit 39 between them and the first inclined side portion S201. In this manner, the first source lead-out wiring line 235α is connected to the first source wiring line 227α and the third source wiring line 227γ via the switch circuit 39, and the second source lead-out wiring line 235B is connected to the second source wiring line 227B and the fourth source wiring line 2278 via the switch circuit 39. The first source lead-out wiring line 235α and the second source lead-out wiring line 235β are disposed on a side opposite to the first inclined side portion S201 side in the display region AA with respect to the switch circuit 39 extending along the first inclined side portion S201. A space for routing the first source lead-out wiring line 235α and the second source lead-out wiring line 235β is reduced is reduced due to the first wiring line portion 235α1 and the third wiring line portion 23531 being disposed overlapping each other, and thus a space required on a side opposite to the first inclined side portion S201 side in the display region AA with respect to the switch circuit 39 can be narrowed, thereby making it possible to achieve a narrow frame near the first inclined side portion S201.

In addition, a first gate wiring line 26α disposed in the display region AA and extending in a second direction, and the first gate drive circuit 214A disposed in the non-display region NAA and connected to the first gate wiring line 26α to supply a signal to the first gate wiring line 26α are provided. The first gate drive circuit 214A extends along the first inclined side portion S201 and is disposed at a position spaced apart from the switch circuit 39. The first source lead-out wiring line 235α and the second source lead-out wiring line 235β are disposed being interposed between the switch circuit 39 and the first gate drive circuit 214A. A signal is supplied to the first gate wiring line 26α in the display region AA from the first gate drive circuit 214A. The first source lead-out wiring line 235α and the second source lead-out wiring line 235β can be disposed in a space between the switch circuit 39 and the first gate drive circuit 214A. A space for routing the first source lead-out wiring line 235α and the second source lead-out wiring line 235β is reduced due to the first wiring line portion 235α1 and the third wiring line portion 235β1 being disposed overlapping each other, and thus a gap between the switch circuit 39 and the first gate drive circuit 214A can be narrowed, thereby making it possible to achieve a narrow frame near the first inclined side portion S201.

### Fourth Embodiment

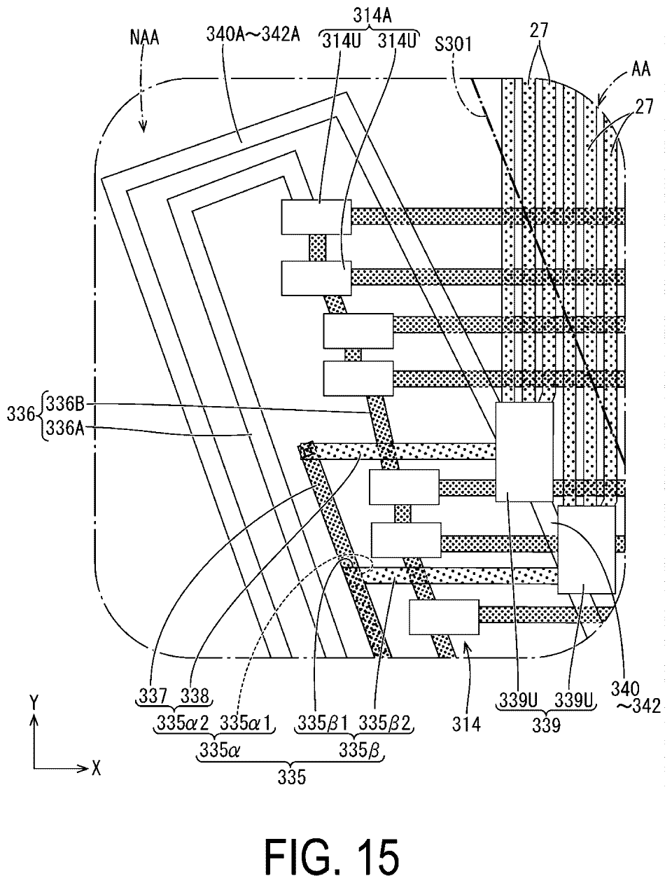

A fourth embodiment will be described with reference to FIG. 15. The fourth embodiment shows a case where the arrangement of a first gate drive circuit 314A and a source lead-out wiring line 335 is changed to be the same as in the second embodiment from the third embodiment described above. Repeated descriptions of structures, actions, and effects similar to those of the second and third embodiments described above will be omitted.

As illustrated in FIG. 15, the first gate drive circuit 314A according to present embodiment is disposed at a position adjacent to a switch circuit 339. The switch circuit 339 is disposed between a first inclined side portion S301 in a display region AA and the first gate drive circuit 314A. A plurality of source lead-out wiring lines 335 (including a first source lead-out wiring line 335α and a second source lead-out wiring line 335β) are disposed sandwiching the first gate drive circuit 314A between them and the switch circuit 339. According to present embodiment, the first source lead-out wiring line 335α and the second source lead-out wiring line 335β can be disposed in a space secured on a side opposite to the switch circuit 339 side with respect to the first gate drive circuit 314A. A space for routing the first source lead-out wiring line 335α and the second source lead-out wiring line 335β is reduced due to a first wiring line portion 335α1 and a third wiring line portion 335β1 being disposed overlapping each other, and thus it is possible to narrow a space required on a side opposite to the switch circuit 339 side with respect to the first gate drive circuit 314A. Thereby, it is possible to achieve a narrow frame near the first inclined side portion S301. In FIG. 15, three switch wiring lines 340 to 342 connected to the switch circuit 339 are simplified and illustrated as one wiring line.

As illustrated in FIG. 15, the switch wiring lines 340 to 342 are disposed such that first switch wiring line portions 340A to 342A, which are portions extending from a terminal portion connected to the driver 12 (see FIG. 1) to a unit switch circuit portion 339U located at the uppermost stage, sandwich a plurality of source lead-out wiring lines 335 between them and the first gate drive circuit 314A. Thus, the first switch wiring line portions 340A to 342A are prevented from crossing the plurality of source lead-out wiring lines 335. Thus, regardless of whether the first switch wiring line portions 340A to 342A are constituted by a first metal film, a second metal film, or a third metal film, it is possible to avoid a short circuit with the source lead-out wiring line 335. Thereby, the degree of freedom of the type of metal film used for the first switch wiring line portions 340A to 342A is increased. Furthermore, in the switch wiring lines 340 to 342, second switch wiring line portions 340B to 342B, which are portions from the unit switch circuit portion 339U located at the uppermost stage to the unit switch circuit portion 339U located at the lowermost stage, are constituted by a part of the first metal film. Furthermore, the gate drive wiring line 336 connected to the first gate drive circuit 314A is constituted by a first drive wiring line portion 336A and a second drive wiring line portion 336B, as in the second embodiment described above.

As illustrated in FIG. 15, each of a plurality of gate lead-out wiring lines 334 is constituted by a part of the first metal film, as in the second embodiment described above. In FIG. 15, a configuration constituted by a part of the first metal film and a configuration constituted by a part of the second metal film are illustrated in different shaded forms. Thus, a fourth wiring line portion 33582 constituted by a part of the second metal film intersects a second gate lead-out wiring line 334β via a first interlayer insulating film 30 (see FIG. 10). The first interlayer insulating film 30 is interposed between the fourth wiring line portion 33582 and the second gate lead-out wiring line 334β, which intersect each other, and thus a short circuit therebetween is prevented. On the other hand, as in the second embodiment described above, the second wiring line portion 335α2 is configured by connecting a first metal film portion 337 constituted by a part of the first metal film and a second metal film portion 338 constituted by a part of the second metal film. A connection structure between the first metal film portion 337 and the second metal film portion 338 is as described in the second embodiment (see FIG. 11). In present embodiment, as in the second embodiment, the first metal film and the second metal film can constitute wiring lines 334α and 334β and wiring line portions 336B, 335α1, 335α2, 335β1, and 335β2. Accordingly, an array substrate 321 does not include the third metal film and the third interlayer insulating film 33 (see FIG. 6) described in the first embodiment. That is, according to present embodiment, the number of metal films provided on the array substrate 321 may be smaller than that in the first embodiment.

As described above, according to present embodiment, a first gate wiring line 326α disposed in the display region AA and extending in the second direction, and the first gate drive circuit 314A disposed in the non-display region NAA and connected to the first gate wiring line 326α to supply a signal to the first gate wiring line 326α are provided. The first gate drive circuit 314A extends along the first inclined side portion S301 and is disposed at a position adjacent to the switch circuit 339. The first source lead-out wiring line 335α and the second source lead-out wiring line 335β are disposed sandwiching the first gate drive circuit 314A between them and the switch circuit 339. A signal is supplied to the first gate wiring line 326α in the display region AA from the first gate drive circuit 314A. The first source lead-out wiring line 335α and the second source lead-out wiring line 335B can be disposed in a space secured on a side opposite to the switch circuit 339 side with respect to the first gate drive circuit 314A. A space for routing the first source lead-out wiring line 335α and the second source lead-out wiring line 335B is reduced due to the first wiring line portion 335α1 and the third wiring line portion 335β1 being disposed overlapping each other, and thus a space required on a side opposite to the switch circuit 339 side with respect to the first gate drive circuit 314A can be narrowed, thereby making it possible to achieve a narrow frame near the first inclined side portion S301.

### Fifth Embodiment

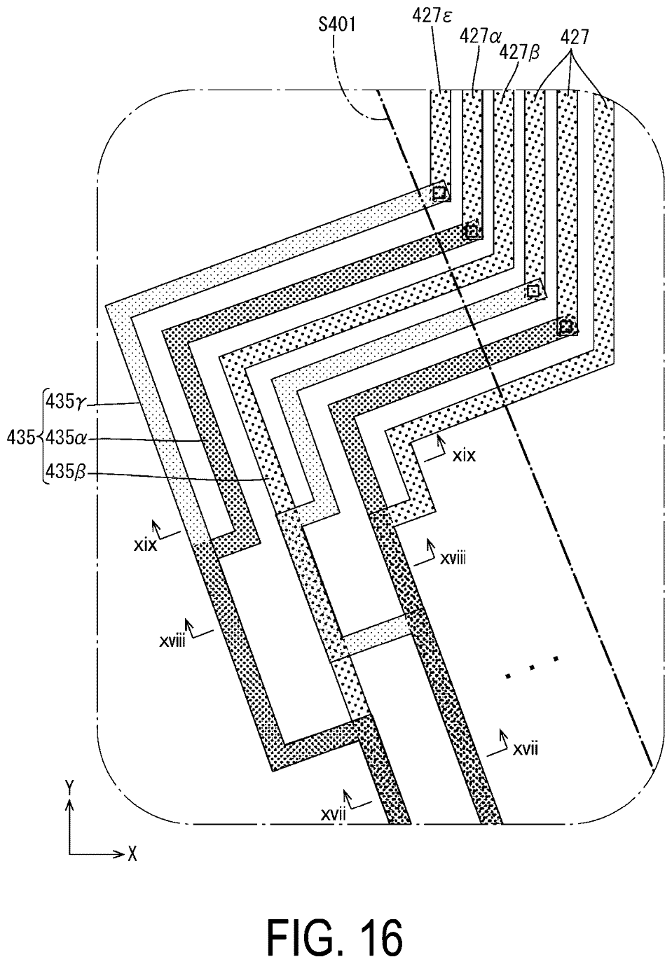

A fifth embodiment will be described with reference to FIGS. 16 to 19. The fifth embodiment shows a case where the configuration of a source lead-out wiring line 435 is changed from that in the first embodiment. Repeated descriptions of structures, actions, and effects similar to those of the first embodiment described above will be omitted.

A plurality of source lead-out wiring lines 435 according to present embodiment include one constituted by a part of a third metal film as illustrated in FIG. 16. Hereinafter, among the plurality of source lead-out wiring lines 435, a source lead-out wiring line 435 constituted by a part of the third metal film will be referred to as a “third source lead-out wiring line (thirteenth wiring line) 435γ”, and among a plurality of source wiring lines 427, a source wiring line 427 connected to the third source lead-out wiring line 435γ will be referred to as a “fifth source wiring line (twelfth wiring line) 427¿”. In FIG. 16, a configuration constituted by a part of a first metal film, a configuration constituted by a part of a second metal film, and a configuration constituted by a part of the third metal film are illustrated in different shaded forms. Furthermore, the fifth source wiring line 4278 is disposed intersecting a first inclined side portion S401 in a display region AA.

In present embodiment, a first source lead-out wiring line 435α, a second source lead-out wiring line 435β, and the third source lead-out wiring line 435γ are disposed partially overlapping each other, as illustrated in FIGS. 16, 17, and 19. Specifically, the third source lead-out wiring line 435Y includes a fifth wiring line portion 435γ1 that overlaps a part of the first source lead-out wiring line 435α (first wiring line portion 435α1) and a part of the second source lead-out wiring line 435β (third wiring line portion 435β1), and a sixth wiring line portion 4352 that overlaps neither the first source lead-out wiring line 435α nor the second source lead-out wiring line 435β. The fifth wiring line portion 435γ1 is connected to a terminal portion that is connected to a driver 12 (see FIG. 1). The sixth wiring line portion 435γ2 is connected to the fifth source wiring line 4278 near the first inclined side portion S401 of the display region AA. The sixth wiring line portion 435γ2, which is constituted by a part of the third metal film, is disposed partially overlapping the fifth source wiring line 427, which is constituted by a part of the second metal film, and is connected through a third wiring line contact hole CH5 formed in a second interlayer insulating film 431 and a flattening film 432 (see the alternating dotted-dashed line in FIG. 16).

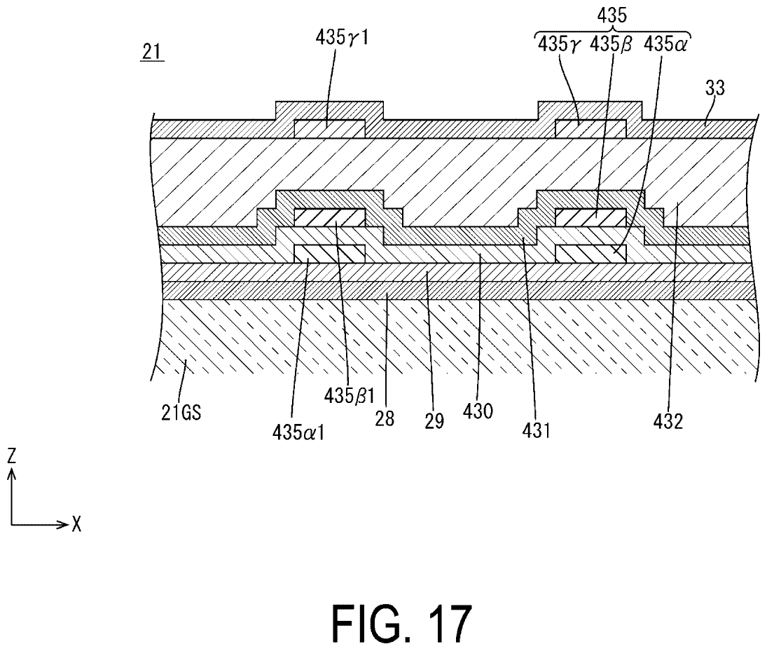

As illustrated in FIG. 17, the fifth wiring line portion 435γ1, which is constituted by a part of the third metal film, is disposed overlapping a third wiring line portion 435β1, which is constituted by a part of the second metal film, via the second interlayer insulating film 431 and the flattening film 432. The fifth wiring line portion 435γ1 and the third wiring line portion 435β1, which overlap each other, are maintained in an insulated state by the second interlayer insulating film 431 and the flattening film 432. In this manner, since the first wiring line portion 435α1, the third wiring line portion 435β1, and the fifth wiring line portion 435γ1 are disposed overlapping each other, a space required to route the first source lead-out wiring line 435α, the second source lead-out wiring line 435β, and the third source lead-out wiring line 435γ can be reduced. Thereby, it is possible to narrow a gap that has to be provided between the first inclined side portion S401 and a gate drive circuit 314, thereby making it possible to achieve a narrow frame near the first inclined side portion S401.

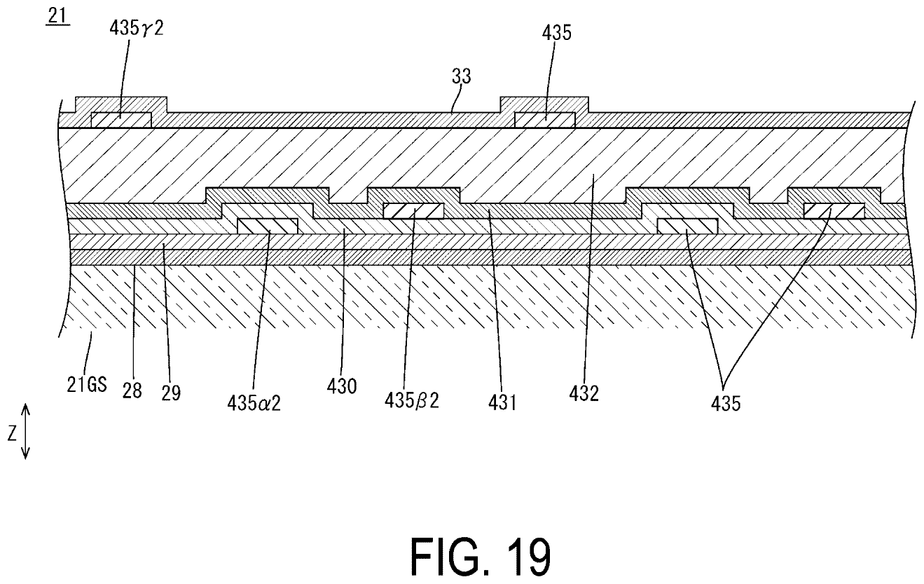

On the other hand, the second wiring line portion 435α2, the fourth wiring line portion 435β2, and the sixth wiring line portion 435γ2 are disposed not to overlap each other as illustrated in FIG. 19, and thus it is possible to reduce parasitic capacitance that may occur between the first source lead-out wiring line 435α, the second source lead-out wiring line 435β, and the third source lead-out wiring line 435γ. Thereby, distortion is less likely to occur in image signals supplied from the driver 12 to the first source lead-out wiring line 435α, the second source lead-out wiring line 435β, and the third source lead-out wiring line 435γ. A first interlayer insulating film 430 is interposed between the second wiring line portion 435α2 constituted by a part of the first metal film and the fourth wiring line portion 435β2 constituted by a part of the second metal film, and the second interlayer insulating film 431 and the flattening film 432 are interposed between the fourth wiring line portion 4352 and the sixth wiring line portion 4352 constituted by a part of the third metal film. Thus, a short circuit is less likely to occur even when an arrangement pitch between the second wiring line portion 435α2, the fourth wiring line portion 435β2, and the sixth wiring line portion 435γ2 becomes narrow.

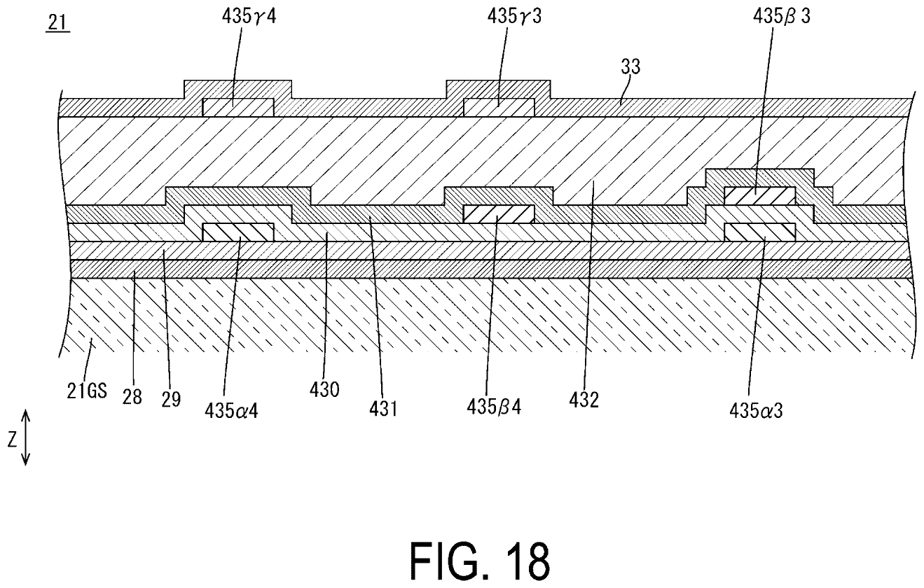

In present embodiment, the first source lead-out wiring line 435α, the second source lead-out wiring line 435β, and the third source lead-out wiring line 435γ are disposed such that two of them partially overlap each other, as illustrated in FIG. 18. The first source lead-out wiring line 435α includes either a seventh wiring line portion 435α3 that overlaps a part of the second source lead-out wiring line 435β but does not overlap the third source lead-out wiring line 435γ, or an eighth wiring line portion 435α4 that overlaps a part of the third source lead-out wiring line 435γ but does not overlap the second source lead-out wiring line 435β. That is, there are two types of first source lead-out wiring lines 435α, that is, one that includes the seventh wiring line portion 435α3 in addition to the first wiring line portion 435α1 and the second wiring line portion 435α2, and one that includes the eighth wiring line portion 435α4. As illustrated in FIG. 16, one end of the seventh wiring line portion 435α3 (eighth wiring line portion 435α4) is connected to an end of the first wiring line portion 435al, and the other end is connected to the second wiring line portion 435α2.

As illustrated in FIG. 18, the second source lead-out wiring line 435β includes either a ninth wiring line portion 435β3 that overlaps a part of the first source lead-out wiring line 435α but does not overlap the third source lead-out wiring line 435γ, or a tenth wiring line portion 435β4 that overlaps a part of the third source lead-out wiring line 435γ but does not overlap the first source lead-out wiring line 435α. That is, there are two types of second source lead-out wiring lines 435β, that is, one that includes an eighth wiring line portion 435β3 in addition to the third wiring line portion 435β1 and the fourth wiring line portion 435β2, and one that includes a ninth wiring line portion 435β4. As illustrated in FIG. 16, one end of the eighth wiring line portion 435β3 (ninth wiring line portion 435β4) is connected to an end of the third wiring line portion 435β1, and the other end is connected to the fourth wiring line portion 435β2.

As illustrated in FIG. 18, the third source lead-out wiring line 435γ includes either an eleventh wiring line portion 435γ3 that overlaps a part of the second source lead-out wiring line 435β but does not overlap the first source lead-out wiring line 435α, or a twelfth wiring line portion 435γ4 that overlaps a part of the first source lead-out wiring line 435α but does not overlap the second source lead-out wiring line 435β. That is, there are two types of third source lead-out wiring lines 435γ, that is, one that includes an eleventh wiring line portion 435γ3 in addition to the fifth wiring line portion 435γ1 and the sixth wiring line portion 435γ2, and one that includes a twelfth wiring line portion 435γ4. As illustrated in FIG. 16, one end of the eleventh wiring line portion 435γ3 (twelfth wiring line portion 435γ4) is connected to an end of the fifth wiring line portion 435γ1, and the other end is connected to the sixth wiring line portion 435γ2.

As illustrated in FIG. 18, the eleventh wiring line portion 435γ3 constituted by a part of the third metal film overlaps the eighth wiring line portion 435α4 constituted by a part of the first metal film via the first interlayer insulating film 430, the second interlayer insulating film 431, and the flattening film 432, but does not overlap the second source lead-out wiring line 435β. Thereby, it is possible to reduce parasitic capacitance that may occur between the second source lead-out wiring line 435B and the third source lead-out wiring line 435γ while reducing a space required to route the first source lead-out wiring line 435α and the third source lead-out wiring line 435γ. The twelfth wiring line portion 435γ4 constituted by a part of the third metal film overlaps the tenth wiring line portion 435β4 constituted by a part of the second metal film via the second interlayer insulating film 431 and the flattening film 432, but does not overlap the first source lead-out wiring line 435α. Thereby, it is possible to reduce parasitic capacitance that may occur between the first source lead-out wiring line 435α and the third source lead-out wiring line 435γ while reducing a space required to route the second source lead-out wiring line 435B and the third source lead-out wiring line 435γ.

As illustrated in FIG. 18, the ninth wiring line portion 435β constituted by a part of the second metal film overlaps the seventh wiring line portion 435α3 constituted by a part of the first metal film via the first interlayer insulating film 430, but does not overlap the third source lead-out wiring line 435γ. Thereby, it is possible to reduce parasitic capacitance that may occur between the second source lead-out wiring line 435B and the third source lead-out wiring line 435Y while reducing a space required to route the first source lead-out wiring line 435α and the second source lead-out wiring line 435β. The tenth wiring line portion 435β4 constituted by a part of the second metal film overlaps the twelfth wiring line portion 435γ4 constituted by a part of the third metal film via the second interlayer insulating film 431 and the flattening film 432, but does not overlap the first source lead-out wiring line 435α. Thereby, it is possible to reduce parasitic capacitance that may occur between the first source lead-out wiring line 435α and the second source lead-out wiring line 435β while reducing a space required to route the second source lead-out wiring line 435β and the third source lead-out wiring line 435Y.

As illustrated in FIG. 18, the seventh wiring line portion 435α3 constituted by a part of the first metal film overlaps the ninth wiring line portion 435B constituted by a part of the second metal film via the first interlayer insulating film 430, but does not overlap the third source lead-out wiring line 435γ. Thereby, it is possible to reduce parasitic capacitance that may occur between the first source lead-out wiring line 435α and the third source lead-out wiring line 435γ while reducing a space required to route the first source lead-out wiring line 435α and the second source lead-out wiring line 435β. The eighth wiring line portion 435α4 constituted by a part of the first metal film overlaps the eleventh wiring line portion 435γ3 constituted by a part of the third metal film via the first interlayer insulating film 430, the second interlayer insulating film 431, and the flattening film 432, but does not overlap the second source lead-out wiring line 435β. Thereby, it is possible to reduce parasitic capacitance that may occur between the first source lead-out wiring line 435α and the second source lead-out wiring line 435β while reducing a space required to route the first source lead-out wiring line 435α and the third source lead-out wiring line 435Y.

As illustrated in FIG. 16, a boundary between the first wiring line portion 435α1 and the seventh wiring line portion 435α3 (eighth wiring line portion 435α4) of the first source lead-out wiring line 435α is disposed on a side opposite to the driver 12 side from a first parallel side portion P1 in the Y-axis direction. Similarly, a boundary between the third wiring line portion 435β1 and the ninth wiring line portion 435β3 (tenth wiring line portion 435β4) of the second source lead-out wiring line 435β is disposed on a side opposite to the driver 12 side from the first parallel side portion P1 in the Y-axis direction. Similarly, a boundary between the fifth wiring line portion 435γ1 and the eleventh wiring line portion 435γ3 (twelfth wiring line portion 435γ4) of the third source lead-out wiring line 435γ is disposed on a side opposite to the driver 12 side from the first parallel side portion P1 in the Y-axis direction. That is, the first wiring line portion 435α1, the third wiring line portion 435β1, and the fifth wiring line portion 435γ1 extend to a side opposite the driver 12 side from the first parallel side portion P1 in the Y-axis direction. In this manner, the first wiring line portion 435α1, the third wiring line portion 435β1, and the fifth wiring line portion 435γ1, which overlap each other, are disposed in the non-display region NAA on a side opposite to the driver 12 side from the first parallel side portion P1 in the Y-axis direction. Thereby, it is possible to preferably achieve a narrow frame near the first inclined side portion S401. More specifically, the length dimensions of the second wiring line portion 435α2 and the seventh wiring line portion 435α3 (eighth wiring line portion 435α4) are each approximately ⅓ of a distance on the first inclined side portion S401 from the end of the first inclined side portion S401 on the first parallel side portion P1 side to an intersection position between the first source wiring line 427α and the first inclined side portion S401. Similarly, the length dimensions of the fourth wiring line portion 435β2 and the ninth wiring line portion 435β3 (tenth wiring line portion 435β4) are each approximately ⅓ of a distance on the first inclined side portion S401 from the end of the first inclined side portion S401 on the first parallel side portion P1 side to an intersection position between the second source wiring line 427β and the first inclined side portion S401. Similarly, the length dimensions of the sixth wiring line portion 435γ2 and the eleventh wiring line portion 435γ3 (twelfth wiring line portion 435γ4) are each approximately ⅓ of a distance on the first inclined side portion S401 from the end of the first inclined side portion S401 on the first parallel side portion P1 side to an intersection position between the fifth source wiring line 4278 and the first inclined side portion S401.

As described above, according to present embodiment, the fifth source wiring line (twelfth wiring line) 4278 disposed in the display region AA and extending in the first direction, and the third source lead-out wiring line (thirteenth wiring line) 435γ disposed in the non-display region NAA and connected to the driver 12 and the fifth source wiring line 4278 are provided. The fifth source wiring line 4278 is disposed intersecting the first inclined side portion S1. The third source lead-out wiring line 435γ includes the fifth wiring line portion 435γ1 constituted by a part of the third metal film (third conductive film) with the second interlayer insulating film 31, which is a second insulating film, and the flattening film 32 interposed between the second metal film and the third metal film, and the sixth wiring line portion 435γ2 constituted by a part of the first metal film, the second metal film, or the third metal film. The fifth wiring line portion 435γ1 is disposed overlapping the first wiring line portion 435α1 and the third wiring line portion 43581. The sixth wiring line portion 435γ2 is disposed not to overlap the second wiring line portion 435α2 and the fourth wiring line portion 435β2 and is connected to the fifth wiring line portion 435γ1 and the fifth source wiring line 4278. The third source lead-out wiring line 435γ disposed in the non-display region NAA is connected to the fifth source wiring line 4278 which intersects the first inclined side portion S1 in the display region AA. The fifth wiring line portion 435γ1, which constitutes the third source lead-out wiring line 435γ and is constituted by a part of the third metal film, is disposed overlapping the third wiring line portion 435β1, which constitutes the second source lead-out wiring line 435 and is constituted by a part of the second metal film, via the second interlayer insulating film 31 and the flattening film 32, which are second insulating films, and is also disposed overlapping the first wiring line portion 435α1, which constitutes the first source lead-out wiring line 435α and is constituted by a part of the first metal film, and thus it is possible to reduce a space for routing the first source lead-out wiring line 435α, the second source lead-out wiring line 435β, and the third source lead-out wiring line 435γ. Thereby, it is possible to further narrow the frame near the first inclined side portion S1. Furthermore, the sixth wiring line portion 435γ2 constituting the third source lead-out wiring line 435γ and connected to the fifth wiring line portion 435γ1 and the fifth source wiring line 427ε is disposed not to overlap the second wiring line portion 435α2 constituting the first source lead-out wiring line 435α and connected to the first wiring line portion 435α1 and the first source wiring line 427α, and the fourth wiring line portion 435β2 constituting the second source lead-out wiring line 435β and connected to the third wiring line portion 435β1 and the second source wiring line 427β, and thus it is possible to reduce parasitic capacitance that may occur between the first source lead-out wiring line 435α, the second source lead-out wiring line 435β, and the third source lead-out wiring line 435γ. Thereby, distortion is less likely to occur in signals supplied from the driver 12 to the first source lead-out wiring line 435α, the second source lead-out wiring line 435β, and the third source lead-out wiring line 435γ.

### Sixth Embodiment

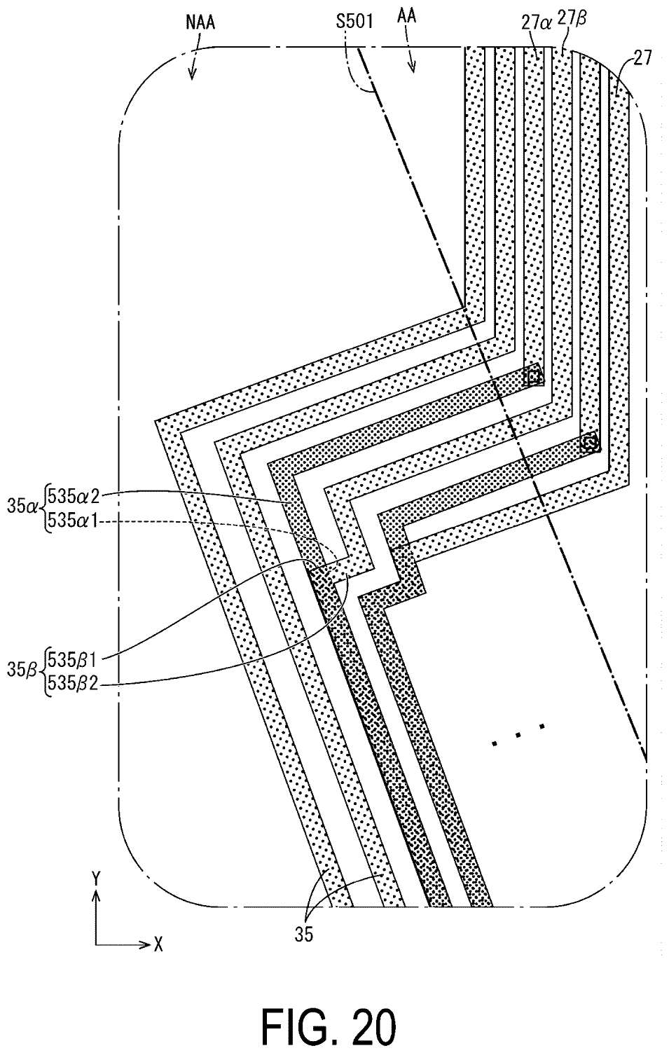

A sixth embodiment will be described with reference to FIG. 20. The sixth embodiment shows a case where configurations of a second wiring line portion 535α2 and a fourth wiring line portion 535β2 are changed from those in the first embodiment described above. Repeated descriptions of structures, actions, and effects similar to those of the first embodiment described above will be omitted.

In present embodiment, a first wiring line portion 535α1 and a third wiring line portion 535β1 extend along a first inclined side portion S501 in a display region AA as illustrated in FIG. 20. The second wiring line portion 535α2 and the fourth wiring line portion 535β2 have a portion that extends along the first inclined side portion S501 and a portion that extends in a direction orthogonal to the first inclined side portion S501. The second wiring line portion 535α2 is constituted by a part of a first metal film in the same manner as the first wiring line portion 535α1, and the fourth wiring line portion 535β2 is constituted by a part of a second metal film in the same manner as the third wiring line portion 535β1. In this manner, a first interlayer insulating film 30 is provided between the second wiring line portion 535α2 constituted by a part of the first metal film and the fourth wiring line portion 535β2 constituted by a part of the second metal film (see FIG. 7). Thereby, it is possible to prevent a short circuit between the second wiring line portion 535α2 and the fourth wiring line portion 535β2 while disposing them at high density. This is particularly useful when a difference in sheet resistance between the first metal film and the second metal film is small.

As described above, according to present embodiment, the second wiring line portion 535α2 is constituted by a part of the first metal film, and the fourth wiring line portion 535β2 is constituted by a part of the second metal film. The first interlayer insulating film 30 is provided between the second wiring line portion 535α2 constituted by a part of the first metal film and the fourth wiring line portion 53532 constituted by a part of the second metal film. Thereby, it is possible to prevent a short circuit between the second wiring line portion 535α2 and the fourth wiring line portion 53532 while disposing them at high density. This is particularly useful when a difference in sheet resistance between the first metal film and the second metal film is small.

### Seventh Embodiment

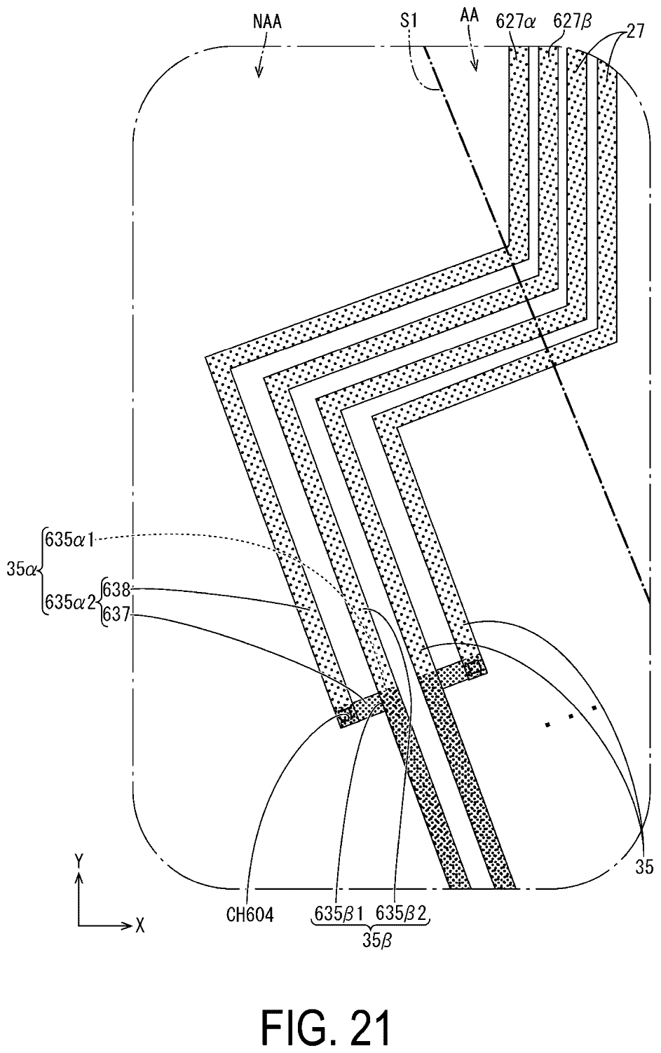

A seventh embodiment will be described with reference to FIG. 21. The seventh embodiment shows a case where the configuration of a second wiring line portion 635α2 is changed from that in the sixth embodiment described above. Repeated descriptions of structures, actions, and effects similar to those in the sixth embodiment described above will be omitted.

As illustrated in FIG. 21, the second wiring line portion 635α2 according to present embodiment includes a first metal film portion 637 constituted by a part of a first metal film, and a second metal film portion 638 constituted by a part of a second metal film, as in the second and fourth embodiments described above. The first metal film portion 637 and the second metal film portion 638 are disposed partially overlapping each other, and are connected through a first contact hole CH604 formed in a first interlayer insulating film 30 interposed therebetween (see FIG. 11). The second metal film portion 638 is connected to a first source wiring line 627α. In this manner, the second metal film portion 638 is connected to a first wiring line portion 635α1 via the first metal film portion 637 which is connected through the first contact hole CH604. Since the second metal film portion 638 connected to the first source wiring line 627α and a fourth wiring line portion 635β2 connected to a second source wiring line 627β are each constituted by a part of the second metal film, a difference in wiring line resistance is less likely to occur between the second wiring line portion 635α2 and the fourth wiring line portion 635β2. This is particularly useful when a difference in sheet resistance between the first metal film and the second metal film is large. Furthermore, in present embodiment, the second metal film constituting the second metal film portion 638 and the fourth wiring line portion 635β2 has a sheet resistance lower than that of the first metal film. In this manner, compared to a case where the second metal film portion and the fourth wiring line portion are each constituted by a part of the first metal film, the wiring line resistance of the second wiring line portion 635α2 and the fourth wiring line portion 635β2 can be reduced.

As described above, according to present embodiment, the fourth wiring line portion 6352 is constituted by a part of the second metal film, the second wiring line portion 635α2 is configured such that the first metal film portion 637, which is constituted by a part of the first metal film, and the second metal film portion 638, which is constituted by a part of the second metal film, are connected through the first contact hole CH604 formed in the first interlayer insulating film (first insulating film) 30, and the second metal film portion 638 is connected to the first source wiring line 627α. The second metal film portion 638 is connected to the first wiring line portion 635α1 through the first metal film portion 637 connected through the first contact hole CH604. Since the second metal film portion 638 connected to the first source wiring line 627α and the fourth wiring line portion 635β2 connected to the second source wiring line 627β are each constituted by a part of the second metal film, a difference in wiring line resistance is less likely to occur between the second wiring line portion 635α2 and the fourth wiring line portion 6352. This is particularly useful when a difference in sheet resistance between the first metal film and the second metal film is large.

Furthermore, the second metal film portion 638 and the fourth wiring line portion 635β2 are each constituted by a part of the second metal film having a sheet resistance lower than that of the first metal film. Compared to a case where the second metal film portion and the fourth wiring line portion are each constituted by a part of the first metal film, the wiring line resistance of the second wiring line portion 635α2 and the fourth wiring line portion 635β2 can be reduced.

### Eighth Embodiment

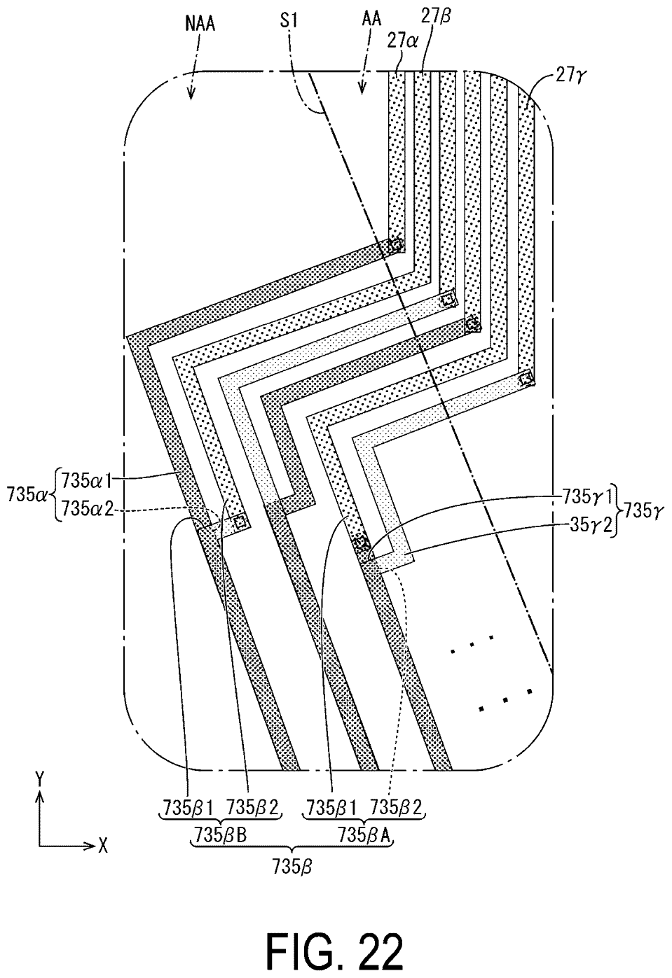

An eighth embodiment will be described with reference to FIG. 22. The eighth embodiment shows a case where the configuration of a second source lead-out wiring line 735β is changed from that in the fifth embodiment. Repeated descriptions of structures, actions, and effects similar to those of the fifth embodiment described above will be omitted.

As illustrated in FIG. 22, in the second source lead-out wiring line 735β according to present embodiment, a third wiring line portion 735β1 includes two types of second source lead-out wiring lines, that is, one second source lead-out wiring line 735βA constituted by a part of a first metal film, and the other second source lead-out wiring line 735βB constituted by a part of a third metal film. In the one second source lead-out wiring line 735βA, the third wiring line portion 735β1 constituted by a part of the first metal film is disposed overlapping a fifth wiring line portion 735γ1 of a third source lead-out wiring line 735γ. In the one second source lead-out wiring lines 735βA, the third wiring line portion 735β1 constituted by a part of the first metal film partially overlaps a fourth wiring line portion 735β2 constituted by a part of the second metal film, and is connected through a contact hole formed in a first interlayer insulating film 30 (see FIG. 11). On the other hand, in the other second source lead-out wiring line 735βB, the third wiring line portion 735β1 constituted by a part of the third metal film is disposed overlapping a first wiring line portion 735α1 of a first source lead-out wiring line 735α. In the other second source lead-out wiring line 735βB, the third wiring line portion 73581 constituted by a part of the third metal film partially overlaps the fourth wiring line portion 735β2 constituted by a part of the second metal film, and is connected through a contact hole formed in a second interlayer insulating film 31 and a flattening film 32.

The first source lead-out wiring line 735α, the second source lead-out wiring line 735β, and the third source lead-out wiring line 735γ according to present embodiment are disposed such that two of them overlap each other, but all of the three do not overlap each other. Specifically, in the first source lead-out wiring line 735α, the first wiring line portion 735α1 is disposed overlapping either the third wiring line portion 735β1 provided in the other second source lead-out wiring line 735β or the fifth wiring line portion 735γ1 provided in the third source lead-out wiring line 735γ. In the third source lead-out wiring line 735γ, the fifth wiring line portion 735γ1 is disposed overlapping either the first wiring line portion 735α1 of the first source lead-out wiring line 735α or the third wiring line portion 735β1 of the second source lead-out wiring line 735βA. As described above, in present embodiment, overlapping portions of the first source lead-out wiring line 735α, the second source lead-out wiring line 735β, and the third source lead-out wiring line 735γ are all constituted by a part of the first metal film and a part of the third metal film.

### OTHER EMBODIMENTS

The technology disclosed in this specification is not limited to the embodiments described above and illustrated in the drawings, and the following embodiments, for example, are also included within the technical scope.

(1) In a configuration in which liquid crystal panels 11 and 211 have a touch panel function, a configuration may be adopted in which a plurality of touch lead-out wiring lines disposed in a non-display region NAA are connected to a plurality of touch wiring lines disposed in a display region AA. For example, a configuration may be adopted in which the plurality of touch wiring lines may include a first touch wiring line (first wiring line) and a second touch wiring line (second wiring line), the plurality of touch lead-out wiring lines may include a first touch lead-out wiring line (third wiring line) and a second touch lead-out wiring line (fourth wiring line), the first touch lead-out wiring line includes the first wiring line portions 35α1, 135α1, 235α1, 335α1, 435α1, 535α1, 635α1, and 735α1 and the second wiring line portions 35α2, 135α2, 335α2, 435α2, 535α2, 635α2, and 735α2 described above, and the second touch lead-out wiring line includes the third wiring line portions 35β1, 135β1, 235β1, 335β1, 435β1, 535β1, 635β1, and 735β1 and the fourth wiring line portions 3582, 13532, 335β2, 435β2, 535β2, 35β2, 635β2, and 735β2 described above. Touch signals are supplied to the plurality of touch wiring lines from drivers 12 and 212 and the like via the plurality of touch lead-out wiring lines.

(2) The planar shapes of the liquid crystal panels 11 and 211 and the planar shape of the display region AA may not match each other. For example, the planar shapes of the liquid crystal panels 11 and 211 may be rectangular shapes, while the planar shape of the display region AA may be a parallelogram shape or the like.

(3) The planar shape of the display region AA may be a trapezoid, a triangle, a polygon with five or more angles, an oval, an ellipse, a semicircle, or the like. The planar shape of an inclined side portion is not limited to a straight line and may be a curved shape (an arc shape or the like).

(4) The specific installation number, arrangement, routing path, line width, and the like of each wiring line provided in a non-display region NAA of each of array substrates 21, 121, 221, and 321 can be appropriately changed to those not illustrated in the drawings.

(5) Gate drive circuits 14 and 314 may be disposed on only one side of the display region AA in the X-axis direction.

(6) The drivers 12 and 212 may be mounted by chip on film (COF) on a flexible substrate 17, which is mounted on the array substrates 21, 121, 221 and 321 by film on glass (FOG).

(7) The material of a semiconductor film constituting a semiconductor portion 24D may be an oxide semiconductor material, amorphous silicon, or the like.

(8) The configuration of a TFT 24 may be a bottom gate type, a double gate type, or the like other than a top gate type.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A display substrate comprising:
a display region in which an image is displayed;
a non-display region in which an image is not displayed;
a first signal supply unit that is disposed in the non-display region at a position spaced apart from the display region in a first direction;
a first wiring line that is disposed in the display region and extends in the first direction;
a second wiring line that is disposed in the display region and extends in the first direction;
a third wiring line that is disposed in the non-display region and is connected to the first signal supply unit and the first wiring line; and
a fourth wiring line that is disposed in the non-display region and is connected to the first signal supply unit and the second wiring line,
wherein an outer peripheral side portion in the display region includes a first inclined side portion that is inclined in the first direction such that a distance from the first signal supply unit increases toward an end in a second direction orthogonal to the first direction,
the first wiring line and the second wiring line are both disposed intersecting the first inclined side portion,
the third wiring line includes a first wiring line portion constituted by a part of a first conductive film and a second wiring line portion constituted by a part of the first conductive film or a second conductive film with a first insulating film interposed between the first conductive film and the second conductive film,
the second wiring line portion is connected to the first wiring line portion and the first wiring line,
the fourth wiring line includes a third wiring line portion constituted by a part of the second conductive film and a fourth wiring line portion constituted by a part of the first conductive film or the second conductive film,
the third wiring line portion is disposed overlapping the first wiring line portion, and
the fourth wiring line portion is disposed not to overlap the second wiring line portion and is connected to the third wiring line portion and the second wiring line.

2. The display substrate according to claim 1, further comprising:
a fifth wiring line that is disposed in the display region and extends in the second direction; and
a second signal supply unit that is disposed in the non-display region and is connected to the fifth wiring line to supply a signal to the fifth wiring line,
wherein the second signal supply unit extends along the first inclined side portion and is disposed at a position spaced apart from the first inclined side portion, and
the third wiring line and the fourth wiring line are disposed being interposed between the first inclined side portion and the second signal supply unit.

3. The display substrate according to claim 1, further comprising:
a fifth wiring line that is disposed in the display region and extends in the second direction; and
a second signal supply unit that is disposed in the non-display region and configured to supply a signal to the fifth wiring line,
wherein the second signal supply unit extends along the first inclined side portion and is disposed at a position adjacent to the first inclined side portion, and
the third wiring line and the fourth wiring line are disposed sandwiching the second signal supply unit between them and the first inclined side portion.

4. The display substrate according to claim 3, further comprising:
a sixth wiring line that is disposed in the display region and extends in the second direction;
a seventh wiring line that is disposed in the non-display region and is connected to the fifth wiring line and the second signal supply unit; and
an eighth wiring line that is disposed in the non-display region and is connected to the sixth wiring line and the second signal supply unit,
wherein the fifth wiring line, the sixth wiring line, the seventh wiring line, the eighth wiring line, and the first wiring line portion are each constituted by a part of the first conductive film,
the first wiring line, the second wiring line, the third wiring line portion, and the fourth wiring line portion are each constituted by a part of the second conductive film,
the fourth wiring line portion intersects the eighth wiring line via the first insulating film,
the second wiring line portion connects a first conductive film portion constituted by a part of the first conductive film and a second conductive film portion constituted by a part of the second conductive film through a first contact hole formed in the first insulating film, and
the second conductive film portion intersects the seventh wiring line via the first insulating film.

5. The display substrate according to claim 3, further comprising:
a ninth wiring line that is disposed in the non-display region and is connected to the second signal supply unit,
wherein the ninth wiring line extends along the first inclined side portion and is disposed sandwiching the third wiring line and the fourth wiring line between the ninth wiring line and the second signal supply unit.

6. The display substrate according to claim 1, further comprising:
a tenth wiring line and an eleventh wiring line that are disposed in the display region and both extend in the first direction; and
a switch circuit that is disposed in the non-display region and is connected to the first wiring line, the second wiring line, the third wiring line, the fourth wiring line, the tenth wiring line, and the eleventh wiring line,
wherein the switch circuit distributes signals transmitted by the third wiring line to the first wiring line and the tenth wiring line and distributes signals transmitted by the fourth wiring line to the second wiring line and the eleventh wiring line, the switch circuit extending along the first inclined side portion and being disposed at a position adjacent to the first inclined side portion, and
the third wiring line and the fourth wiring line are disposed sandwiching the switch circuit between them and the first inclined side portion.

7. The display substrate according to claim 6, further comprising:
a fifth wiring line that is disposed in the display region and extends in the second direction; and
a second signal supply unit that is disposed in the non-display region and is connected to the fifth wiring line to supply a signal to the fifth wiring line,
wherein the second signal supply unit extends along the first inclined side portion and is disposed at a position spaced apart from the switch circuit, and
the third wiring line and the fourth wiring line are disposed being interposed between the switch circuit and the second signal supply unit.

8. The display substrate according to claim 6, further comprising:
a fifth wiring line that is disposed in the display region and extends in the second direction; and
a second signal supply unit that is disposed in the non-display region and is connected to the fifth wiring line to supply a signal to the fifth wiring line,
wherein the second signal supply unit extends along the first inclined side portion and is disposed at a position adjacent to the switch circuit, and
the third wiring line and the fourth wiring line are disposed sandwiching the second signal supply unit between them and the switch circuit.

9. The display substrate according to claim 1, further comprising:
a twelfth wiring line that is disposed in the display region and extends in the first direction; and
a thirteenth wiring line that is disposed in the non-display region and is connected to the first signal supply unit and the twelfth wiring line,
wherein the twelfth wiring line is disposed intersecting the first inclined side portion,
the thirteenth wiring line includes a fifth wiring line portion constituted by a part of a third conductive film including a second insulating film, which is interposed between the third conductive film and the second conductive film, and a sixth wiring line portion constituted by a part of the first conductive film, the second conductive film, or the third conductive film,
the fifth wiring line portion is disposed overlapping the first wiring line portion and the third wiring line portion, and
the sixth wiring line portion is disposed not to overlap the second wiring line portion and the fourth wiring line portion, and is connected to the fifth wiring line portion and the twelfth wiring line.

10. The display substrate according to claim 1,
wherein the second wiring line portion is constituted by a part of the first conductive film, and
the fourth wiring line portion is constituted by a part of the second conductive film.

11. The display substrate according to claim 1,
wherein the fourth wiring line portion is constituted by a part of the second conductive film,
the second wiring line portion connects a first conductive film portion, which is constituted by a part of the first conductive film, and a second conductive film portion, which is constituted by a part of the second conductive film, through a first contact hole formed in the first insulating film, and
the second conductive film portion is connected to the first wiring line.

12. The display substrate according to claim 11,
wherein the second conductive film portion and the fourth wiring line portion are each constituted by a part of the second conductive film having a sheet resistance lower than a sheet resistance of the first conductive film.

13. The display substrate according to claim 1,
wherein the outer peripheral side portion in the display region includes a first parallel side portion that is continuous with an end of the first inclined side portion on a first signal supply unit side and is parallel to the second direction, and
the first wiring line portion and the third wiring line portion extend to a side opposite to the first signal supply unit side from the first parallel side portion in the first direction.

14. A display device comprising:
the display substrate according to claim 1; and
a counter substrate that is disposed facing the display substrate.
